(19) United States
(12) Patent Application Publication
(10) Pub. No.: US 2018/0013658 A1
(43) Pub. Date: Jan. 11, 2018

(54) METHOD OF COMMUNICATING BETWEEN NODES IN A COMPUTERIZED NETWORK AND SYSTEM THEREOF

(71) Applicant: AGT INTERNATIONAL GMBH, Zurich (CH)

(72) Inventors: Alexander WIESMAIER, Ober-Ramstadt (DE); Konstantinos MATHIOUDAKIS, Weiterstadt (DE); Alessandro LEONARDI, Darmstadt (DE)

(21) Appl. No.: 15/203,086

(22) Filed: Jul. 6, 2016

(51) Int. Cl. H04L 12/751

(52) U.S. Cl. CPC H04L 45/02

(57) ABSTRACT

The presently disclosed subject matter includes a system, a method and a computer program product enabling communication between nodes, by establishing neighborhood relationships between nodes belonging to a network. When an originator node generates an event, data relating to the event is sent to neighboring nodes of the originator node and to the parent node of the originator node for facilitating association of new neighboring nodes to the originator nodes. If a response is received from a receiving node, the receiving node is updated as a new neighboring node to the originator node.

### TECHNICAL FIELD

The presently disclosed subject matter relates to computerized networks and, more particularly, to communicating between nodes in hierarchical computerized networks.

### BACKGROUND

A topology in a computer network is defined to be the arrangement of the various components (such as nodes) in the network. Physical topology should be construed to include the interconnecting design, i.e., the physical placement of the various components in the network, such as their cable connectivity and physical location. Besides the physical topology of a network, a logical topology may be defined. Logical topology should be construed to illustrate how data is distributed within the components of the network, regardless of their physical interconnecting design.

The logical topology of a network includes definition of the neighborhood relationship between the components of the network, e.g. the nodes, meaning a node in the network can constitute a neighboring node of another node in the network. Data distribution in the network can be affected by the neighborhood relationship between nodes. Since the logical topology is not necessarily the same as the physical topology, neighboring nodes (also referred to herein as “neighbor(s)”) in a logical topology may not necessarily form neighborhood relationships in the underlying physical topology. The opposite situation may also occur, where neighboring nodes in the physical topology will not be considered neighboring nodes in the logical topology.

Some known solutions to establish neighborhood relationships, and communicate, based on these relationships, rely on network physical topology and/or networking parameters, e.g., delay, collisions, node density, etc. For example, according to some known solutions, neighboring nodes in the network are defined to be two nodes that are within the transmission range of each other and have at least one common channel between them, or nodes that are physically deployed next to each other. However, neighborhood relationships between nodes, for example in the field of Internet of Things (IoT), are often not defined by network topology (or even physical proximity), but rather by other properties, such as sensor capabilities, e.g., the ability of two neighboring sensors to capture sensed data of a certain type. Moreover, dynamic changes may affect the neighborhood relationships between nodes.

There is thus a need in the art to provide a solution for establishing a neighborhood relationship and communication between nodes within a logical topology of a network.

A prior art reference considered relevant as a background to the invention appears below and its content is incorporated herein by reference. Acknowledgement of this reference herein is not to be inferred as meaning that this is in any way relevant to the patentability of the invention disclosed herein.

According to the article of Xiao Wei, Qing Li, et al. Building the Data Association Network of Sensors in the Internet of Things. Automatika: Journal for Control, Measurement, Electronics, Computing and Communications (SCI) in the Internet of Things, wireless sensor networks (WSN) are in charge of gathering and transferring environment data. It is an essential work to mine data semantic in WSN, in the data derived from sensors to improve the WSN. The article proposes that the Data Association Network of sensors (DAN) organizes the mined association semantic relations among sensors into an effective form. Because DAN holds the rich data semantic of WSN, it can improve WSN in some aspects, such as detecting abnormal sensors, simulating the data of faulty sensors, or optimizing the topology of WSN. Experimental results show that the proposed method can mine the associated relations among sensor nodes effectively, and the DAN is helpful in solving some problems of WSN.

### GENERAL DESCRIPTION

According to one aspect of the presently disclosed subject matter there is provided a method for communicating between nodes, by a processor of an originator node, comprising: providing a data storage that is associated with the originator node for storing neighboring data indicative of at least one neighboring node of the originator node; generating an event; sending a generated event data relating to said generated event to at least one neighboring node for facilitating processing of said generated event data by a processor of each one of said at least one neighboring node; selectively sending said generated event data to a parent node associated with said originator node, for facilitating the association of at least one new neighboring node to said originator node; if a response to said sent generated event data, which originated from at least one new neighboring node, is received at said originator node, then based on said response, updating said neighboring data to include data indicative of the at least one new neighboring node.

In addition to the above features, the method according to this aspect of the presently disclosed subject matter can comprise one or more of features (i) to (xviii) listed below, in any desired combination or permutation, which is technically possible:
i. wherein each one of said at least one neighboring node is associated with a class out of at least two classes.
ii. wherein said sending generated event data to a neighboring node associated with a first class of said at least two classes includes sending a first generated event data, and said sending generated event data to a neighboring node associated with a second class of said at least two classes includes sending a second generated event data, wherein said second generated event data is at least partially different than said first generated event data.
iii. wherein said generated event is associated with at least one event characteristic.
iv. wherein said event characteristic is content aware.
v. wherein said event characteristic is non-content aware.
vi. wherein said event characteristic is time related.
vii. wherein said originator node includes a sensor and wherein said generated event is sensed data obtained by said sensor.
viii. wherein said sensor is one of: an image acquisition means, an audio acquisition means, license plate recognition (LPR) means and motion detection means.
ix. wherein the method further comprising: in response to sending the generated event data to at least one neighboring node, receiving a neighboring response from the at least one neighboring node, and updating the class associated with the at least one neighboring node as either said first class, second class or a trash class, depending on characteristics of the response.
x. wherein the updating of the neighboring data includes updating a class associated with the at least one new neighboring node as either said first class or second class, depending on characteristics of the response.
xi. wherein said response characteristics are at least one of: duration of time to receive the response from the neighboring node, number of responses previously received from the neighboring node, and a physical distance from the originator node.
xii. wherein said response characteristics are at least one of: duration of time to receive the response from the neighboring node, and a physical distance from the originator node.
xiii. wherein the method of claim 1, further comprising: removing neighboring data that pertains to a neighboring node if a removal criterion is met.
xiv. wherein at least one neighboring node of said neighboring data is a neighbor of the originator node and the originator node is not necessarily a neighbor of the neighboring node.
xv. wherein said selectively sending said generated event data comprises determining that a condition is met, and sending said generated event data.
xvi. wherein said condition is met wherein said condition includes at least one of the following: if after sending a previous generated event data to the parent node a given time interval has lapsed, if after sending a previous generated event data to the parent node a random time has elapsed, if after sending a previous generated event data to the parent node a number of generated events exceed a predefined value, and if, after sending a previous generated event data to the parent node, a number of generated events equals a random value.
xvii. wherein each one of the neighboring nodes in the neighboring data is associated with at least one group, wherein said sending the generated event data includes sending the generated event data to a first neighboring node associated with one group, and not sending the generated event data to any second neighboring node associated with another group.
xviii. wherein the method further comprising: sending at least part of the neighboring data to the parent node.

According to another aspect of the presently disclosed subject there is provided a method for communicating between nodes by a processor of a receiving node, comprising: providing a data storage that is associated with the receiving node for storing a generated event data relating to at least one event generated by an originator node and received from a parent node that is associated with said receiving node; generating a new event; determining based on data relating to said newly generated event and said stored generated event data whether a condition has been met; and if the condition is met, sending a response to the originator node indicative of meeting the condition thereby facilitating association of the receiving node to said originator node as a new neighboring node.

In addition to the above features, the method according to this aspect of the presently disclosed subject matter can comprise one or more of features (i) to (xiv) listed below, in any desired combination or permutation, which is technically possible:
i. wherein said data storage further stores at least one function, each function is indicative of how to determine whether the condition is met, the method further comprising: retrieving at least one stored function; and based on the at least one retrieved function, determining whether the condition is met.
ii. wherein said at least one function is characterized by at least one predefined sequence of events, and wherein the condition is met if a generated sequence of events of said data relating to said newly generated event and said generated event data fulfill said function character.
iii. wherein said predefined sequence of events relates to at least two events, wherein at least one event of said at least one event is generated by a node other than the originator node.
iv. wherein said at least one function is further characterized by a particular node associated with each of the events in the predefined sequence of events.
v. wherein said at least one function is further characterized by a time tag associated with each event of the sequence of events.
vi. wherein a time tag is associated with each event in said generated event data and said newly generated event, and wherein the storing of the generated event data is based on the time tag of each event.
vii. wherein said at least one predefined sequence of events is represented as a state machine.
viii. wherein said data storage further stores neighboring data indicative of at least one neighboring node of the receiving node, wherein said receiving node further constitutes an originator node, the method further comprising: sending newly generated event data relating to said newly generated event to at least one neighboring node, for facilitating processing of said newly generated event data by a processor of each one of said at least one neighboring nodes.
ix. wherein the method further comprising: selectively sending data relating to said newly generated event to the parent node for facilitating the association of at least one new neighboring node to said receiving node.
x. wherein if the condition is met, the method further comprises: processing said newly generated event using said generated event data.
xi. wherein if the condition is met, the method further comprises: using said generated event data to modify generation of at least one second event.
xii. wherein each one of said newly generated event and said at least one event generated by an originator node are content aware or non-content aware.
xiii. wherein at least one event generated by an originator node and said newly generated event are content aware, said at least one function is a similarity criterion function, and wherein the condition is met if at least one event generated by an originator node and data relating to said newly generated event fulfill said similarity criterion function.
xiv. wherein said data storage further stores stored event data relating to at least one event generated by at least one other originator node, and received from the parent node, the method further comprising: determining based on data relating to said generated event and said stored event data whether a condition has been met; and if the condition is met, sending a response to the at least one other originator node indicative of meeting the condition thereby facilitating association of the originator node as a new neighboring node to said at least one other originator node.

According to another aspect of the presently disclosed subject matter there is provided a method for facilitating association of a new neighboring node to an originator node, by a processor of a parent node, the method comprising: providing a data storage that is associated with the parent node for storing child nodes data indicative of at least one child node of the parent node; obtaining a generated event data relating to an event generated by the originator node; sending said generated event data to at least one child node, for storing said generated event data in a child nodes data storage associated with said child node, determining by said child node based on said generated event data and data relating to a second event generated by said child node whether a condition has been met, and originating from said child node, a response to the originator node indicative of meeting the condition, thereby facilitating association of the child node as a neighboring node to said originator node.

In addition to the above features, the method according to this aspect of the presently disclosed subject matter can comprise one or more of features (i) to (x) listed below, in any desired combination or permutation, which is technically possible:
i. wherein said generated event data is obtained from a child node of said parent node, said child node constituting the originator node.
ii. wherein said generated event data is obtained from a grandparent node, constituting a parent node of said parent node and a grandparent node to each one of said child nodes of said parent node.
iii. wherein said data storage further stores neighboring data, indicative of at least one neighboring node of the parent node.
iv. wherein said generated event data is obtained from a neighboring node of said parent node.
v. wherein said sending the generated event data includes sending said generated event data to at least one child node of said parent node and not sending said generated event data to said originator.
vi. wherein said child data is further related to child neighboring nodes indicative of at least one neighboring node associated with each of said at least one child node, wherein said sending the generated event data includes sending said generated event data to at least one child node of said parent node and not sending said generated event data to at least one of said neighboring nodes of said at least one child node of said parent node.
vii. wherein said generated event data is obtained from a child node of said parent node, the method further comprising: sending said generated event data to at least one neighboring node.
viii. wherein the method further comprising: selectively sending said generated event data to a grandparent node, constituting a parent node of said parent node, and a grandparent node to each one of said child nodes of said parent node, for facilitating the association of at least one new neighboring node to said originator node.
ix. wherein said child nodes data is further related to child neighboring node data indicative of at least one neighboring node associated with each of said at least one child node, the method further comprising: receiving from said at least one child node at least part of an updated child neighboring node data; and selectively updating the respective child neighboring node data stored in said data storage.
x. wherein said data storage further stores neighboring data, indicative of at least one neighboring node of the parent node, and wherein each of said at least one child neighboring node in said child neighboring node data is further associated with a respective parent node, and said at least part of an updated child neighboring node data is further indicative of a respective parent node for each updated child neighboring node, the method further comprising: selectively updating the stored neighboring data indicative of at least one neighboring node of the parent node to include data related to at least one updated respective parent node associated with the updated child neighboring node.

According to another aspect of the presently disclosed subject matter there is provided a computerized system enabling communication between nodes, the system comprising: a plurality of originator nodes, each originator node is associated with an originator node's data storage configured to store neighboring data indicative of at least one neighboring node of the originator node; a plurality of receiving nodes, each receiving node is associated with a receiving node's data storage configured to store generated event data relating to at least one event generated by an originator node of said plurality of originator nodes; a plurality of parent nodes, each parent node is associated with a parent node's data storage configured to store child nodes data indicative of at least one child node of the parent node, and each parent node constituting a parent to at least one receiving node of said plurality receiving nodes, wherein an originator node of said plurality of originator nodes is configured to generate an event and send generated event data relating to said generated event to at least one neighboring node, for facilitating processing of said generated event data by a processor of each one of said at least one neighboring nodes; wherein a parent node of said plurality of parent nodes is configured to obtain said generated event data and to send said generated event data to at least one child node; wherein a receiving node of said plurality of receiving nodes is configured to receive said generated event data from said one parent node, to store said generated event data in a receiving node's data storage associated therewith, wherein said receiving node is configured to determine based on said generated event data and data indicative of a second event, generated by said receiving node, whether a condition has been met; and if the condition is met, to send a response to the originator node indicative of meeting the condition; said originator node is configured to update said neighboring data to include data indicative of said receiving node.

In addition to the above features, the system according to this aspect of the presently disclosed subject matter can comprise one or more of the two features listed below, in any desired combination or permutation, which is technically possible:
i. wherein said parent node and said originator node are identical, wherein said parent node is configured to generate an event thereby obtaining said generated event data.
ii. wherein at least one of said plurality of originator nodes receiving nodes and parent nodes, belong to a group comprising: a smart switch and a gateway.

According to another aspect of the presently disclosed subject matter there is provided a computer program product implemented on a non-transitory computer useable medium having computer readable program code embodied therein for communicating between nodes, by a processor of an originator node, the computer program product comprising: computer readable program code for causing the computer to provide a data storage that is associated with the originator node for storing neighboring data indicative of at least one neighboring node of the originator node; computer readable program code for causing the computer to generate an event; computer readable program code for causing the computer to send generated event data relating to said generated event to at least one neighboring node for facilitating processing of said generated event data by a processor of each one of said at least one neighboring node; computer readable program code for causing the computer to selectively sending said generated event data to a parent node associated with said originator node, for facilitating the association of at least one new neighboring node to said originator node; computer readable program code for causing the computer if a response to said sent generated event data, originated from at least one new neighboring node, is received at said originator node, then based on said response, updating said neighboring data to include data indicative of the at least one new neighboring node.

Additionally or alternatively to the above, the method, the system and the computer program product disclosed in accordance with the presently disclosed subject matter can optionally comprise one or more of features listed above, mutatis mutandis, in any desired combination or permutation.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a high level functional block diagram schematically illustrating a network enabling establishing neighborhood between nodes in accordance with certain embodiments of the presently disclosed subject matter;

FIG. 2 is an example of a functional block diagram of a node, in accordance with certain embodiments of the presently disclosed subject matter;

FIG. 3 is an example of a functional block diagram of a parent node, in accordance with certain embodiments of the presently disclosed subject matter;

FIG. 4 is a flowchart exemplifying operations which are carried out at the originator node side, in accordance with certain embodiments of the presently disclosed subject matter;

FIG. 5 is a flowchart exemplifying operations which are carried out at the receiving node side, in accordance with certain embodiments of the presently disclosed subject matter;

FIG. 6 is a flowchart exemplifying operations which are carried out at the parent node, in accordance with certain embodiments of the presently disclosed subject matter; and

FIG. 7 is a flowchart exemplifying operations which are carried out by several nodes in the system, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “providing”, “generating”, “sending”, “updating”, “receiving”, “removing”, “determining”, “retrieving”, “storing”, “processing”, “using”, “modifying”, “obtaining”, “facilitating” or the like, refer to the action(s) and/or process(es) of a computer that manipulate and/or transform data into other data, said data represented as physical, such as hardware-based electronic, quantities and/or said data representing the physical objects. The term “computer” should be expansively construed to cover any kind of electronic device with data processing capabilities including, by way of non-limiting example, the types of nodes (e.g. originator node, receiver node, parent node, etc.) disclosed in the present application.

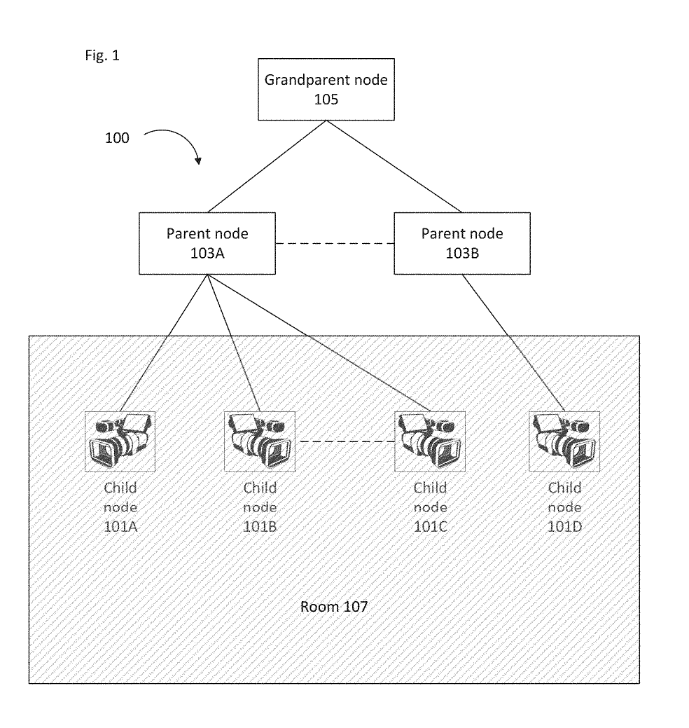

It is noted that the teachings of the presently disclosed subject matter are not bound by the computerized system described with reference to FIG. 1. Equivalent and/or modified functionality can be consolidated or divided in another manner and can be implemented in any appropriate combination of software with firmware and/or hardware and executed on a suitable device. The system can be a standalone network entity, or integrated, fully or partly, with other network entities. Those skilled in the art will also readily appreciate that the data repositories can be consolidated or divided in other manners; databases can be shared with other systems or be provided by other systems, including third party equipment.

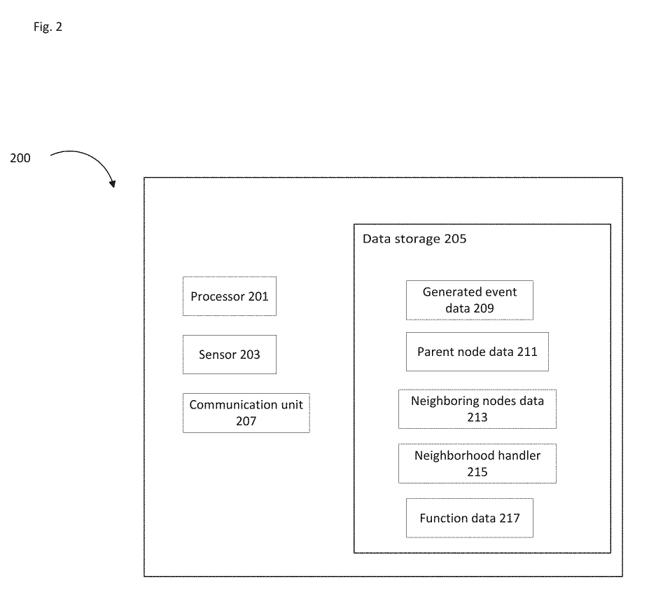

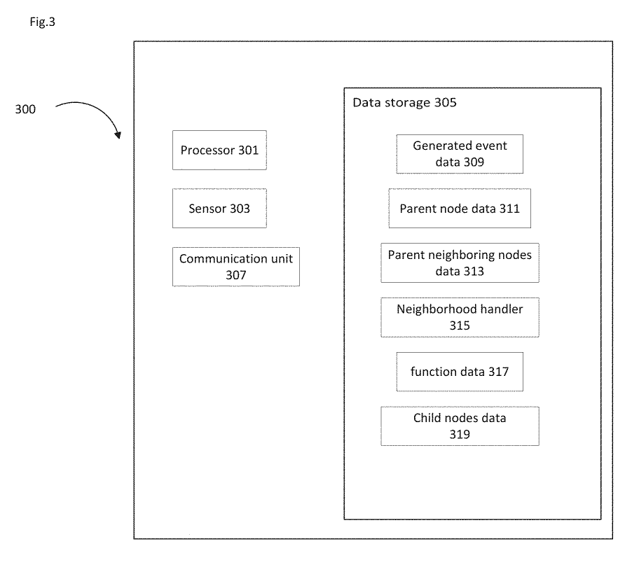

Node 200 and parent node 300 illustrated in FIGS. 2 and 3 may be, but are not limited to, computers, server computers, personal computers, portable computers, Smartphones, appliances, watches, cars, televisions, tablet devices or any other computerized device configured with adequate processing power and communication facility.

The types of nodes such as originator node, receiving node, child node, parent node and grandparent node illustrated in the Figures, each comprise or otherwise are associated with a non-transitory computer memory operatively coupled to one or more processors configured to execute the operations as disclosed herein. The terms “non-transitory memory” and “non-transitory storage medium” as used herein should be expansively construed to cover any volatile or non-volatile computer memory suitable to the presently disclosed subject matter. The term processor as used herein should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

As will be further discussed with reference to FIGS. 2 and 3, the processor (201 and 301) can be configured to execute several functional modules in accordance with computer-readable instructions implemented on a non-transitory computer-readable storage medium.

The term “generate instructions” or any variation thereof as used herein should be broadly interpreted to include the generation of a signal (e.g. electric signal, electromagnetic signal, optical signal, data signal (e.g. comprising one or more bits and/or electronic signature)) for controlling the operation of another machine or device.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Sharing data between neighboring nodes in a physical topology, e.g. based on physical proximity or network parameters, such as low collision rate, has its advantages. However, in some cases, neighboring nodes are flooded with irrelevant information which is received at the nodes merely because they constitute neighbors of some other nodes in the physical network. Moreover, other important information, which could have been valuably used by the nodes, is not sent to them for the same reasons.

Defining neighborhood relationships in a logical topology and sharing data based on the defined neighborhood relationships, in accordance with an aspect of the invention, may assist in more efficient distribution of data between nodes in the network.

Bearing all of the above in mind, the presently disclosed subject matter includes, inter alia, a system and method for communicating between nodes in a communication network.

According to a non-limiting example, a hierarchical computerized network of three layers is provided. The network may be comprised of a plurality of child nodes, where each child node has one parent only, in accordance with the definition of a hierarchical network (however, several child nodes may constitute child nodes of a single parent node). Each parent node may also have one parent node, constituting a grandparent node to the child nodes. The connection between the child node, the parent nodes and the grandparent node is based on physical connections of the network, where, initially, no logical connection or neighborhood relationship between nodes is defined.

An originator node, constituting one of the child nodes in the network, may generate an event. For example, the originator node may be a camera, where the generation of the event may be capturing an image using an acquisition means (such as a camera in this example). After the originator node generates an event, the originator node may distribute data relating to the generated event (also referred to herein as “generated event data”) to other nodes in the network. Details relating to types of events, which may be generated by an originator node, as well as data relating to the generated event, which may be sent by the originator node to other nodes in the network, are further provided below.

Communicating the generated event data by the originator node may have two main purposes. The first purpose is to facilitate processing of the generated event data by neighboring nodes of the originator node, optionally in real time. The second purpose is for establishing new neighboring relationships to the originator node, e.g. by facilitating association of new neighbors to the originator node. Other purposes for communicating the generated event data by the originator node are further described below.

In order to facilitate processing of the generated event data by neighboring nodes of the originator node, originator node may send generated event data to one or more neighboring nodes of the originator node. Data identifying the neighboring nodes of the originator node (also referred to herein as: “neighboring data”) may be stored in a data storage associated with the originator node, and may be used by the originator node in order to identify its neighbors and to send them generated event data. Further details relating to the data storage and neighboring data will be provided with respect to FIG. 3.

Considering the example above where the originator node is a camera capturing an image, the originator node may send a copy of the captured image (being a specific example of a generated event data) to its neighbors (if any neighbors are associated with the originator node). The neighbors may process the received image to extract relevant data, such as an angle of the camera capturing the image, or extract a face detected in the image. Processing the event data by the neighboring nodes can be done e.g. in real time. Further examples of extracted relevant data are described below. The neighboring node may then utilize the extracted relevant data. For example, the neighboring nodes may utilize the extracted relevant data to process following images that are later generated by the neighbor. Another example is that the neighboring node may utilize the extracted relevant data to modify the generation of future images that are later generated by the neighboring node. Consider an example where a neighboring node extracted a face detected in the received image (the face being an example of extracted relevant data). The neighboring node may capture a new image (generate a new event by the neighboring node) and process the new image to detect the face recognized in the received image. In this example, the neighboring node processed future events using the extracted relevant data. The neighboring node can also use the detected face to modify generation of new images, by switching to face detection mode and capturing the future images using this mode.

Sending the generated event data by the originator node to its neighboring node, as described above, is for the purpose of facilitating processing of the generated event data by the neighboring node(s). It should be noted that although initially, no neighboring nodes are associated with the originator node, once neighborhood relationships are established between the originator node and new neighboring nodes, the originator node may send them generated event data, as described above.

In addition to sending generated event data to its neighbors, according to certain embodiments of the presently disclosed subject matter, the originator node may send the generated event data also to other nodes in the network, for establishing new neighboring relationships to the originator node, e.g. by facilitating association of new neighbors to the originator node. To accomplish this purpose, the originator node selectively sends the generated event data also to a parent node. The parent node constitutes a parent node to the originator node in the physical topology. The parent node may send the generated event data to other nodes in the network, such as its child nodes.

According to certain embodiments of the presently disclosed subject matter, the parent node may also send the generated event data to other nodes such as its neighboring nodes or its parent node (the grandparent node). The following disclosure exemplifies how the parent node sends the generated event data to its child nodes. Further description of how the parent node sends the generated event data also to its neighbors and its parent node will be provided below, with reference to the drawings.

According to certain embodiments of the presently disclosed subject matter, the parent node may send the generated event data to one or more of its child nodes, which constitute child nodes in the physical topology.

Any child node which receives the generated event data, is also referred to herein as a “receiving node” or a “receiving child node”, and can store the received generated event data in a data storage that is associated with the child node. The child node may generate by itself a new event, and may subsequently determine, based on the stored generated event data, and data relating to the newly generated event, whether a condition has been met. Consider, as a non-limiting example, that the stored event data is a copy of an image captured by an originator node, and the receiving child node also generates a new event by capturing an image, using an acquisition means such as a camera, included in the receiving child node. In order to determine, based on the stored generated event data (stored image), and data relating to the newly generated event (new captured image), whether a condition has been met, the receiving child node may compare the two images, and determine that a condition has been met, if a certain person detected in the stored image, is also detected in the newly generated image. Further details of how to determine whether a condition has been met, by a receiving node, are further included below.

If the receiving child node determines that a condition has been met, the receiving child node may send a response to the originator node to indicate that the condition has been met. Sending a response from the receiving node may therefore facilitate association of the receiving child node as a new neighboring node to the originator node. Upon receipt of a response from a receiving child node, the originator node may update the stored neighboring data (associated with the originator node) to include data indicative of the receiving child node, as a new neighboring node. If more than one response is received at the originator node of meeting a condition, the originator node may update the neighboring data to include data indicative of any receiving child node that originated a response.

It should be noted that the term “originator node” should be construed to include a node that generates an event and sends data relating to the event, i.e. generated event data, to another node in the network. Likewise, the term “receiving node” should be construed to include a node which receives and stores the event data and may be referred to herein as a “receiving node”.

It should be noted that sending and receiving communication may not necessarily occur directly between the originator and receiving nodes, and can be transmitted using one or more parent nodes in the network. Also, the terms “originator node” and “receiving node” as used herein should be expansively interpreted to include any computerized nodes in a hierarchal communication network, wherein each node has one parent. A node may constitute both an “originator node” and a “receiving node” simultaneously. Moreover, it should be noted that not only an end node in a network may constitute an “originator node” and/or a “receiving node”, but also a parent node, having one or more child nodes, may have the role of an “originator node” and/or a “receiving node”, and can form a neighborhood relationship using the subject matter disclosed herein.

According to a non-limiting example, certain embodiments of the presently disclosed subject matter may be applied in an object tracking scenario.

In a typical, yet not exclusive example of object tracking, event data is generated by an originating node (e.g. an image of a given person to be tracked that is acquired by an originator node). The generated event data is sent to a neighboring node and stored therein. The neighboring node may utilize the stored data for more efficient processing, e.g. operate in face recognition mode in order to ascertain if an event generated at its end (e.g. an acquired image) includes the image of the given person.

In accordance with another example that concerns enrichment of neighborhood relationships, the specified originator node sends the generated event data not only to a neighboring node as exemplified above, but also to a parent node, which in turn sends the generated event data to any one, or selected child nodes (parent nodes to other child nodes). Each of the receiving child nodes stores the data, and in case an event generated at their end and the so stored event data meet a given condition, then the specific child node may constitute a neighbor of the originator node. To this end, a proper notification (in the form of a response) is sent from the child node directly to the originator node. The originator node updates its neighboring data to include also the child node that originated the response. The net effect is that the next generated event at the originator end will be sent not only to any child node that was already included in the neighboring data, but also to the child node which has now been updated to the neighboring data. The neighboring data thus reflect the neighborhood relationships between nodes, i.e. the logical connection between nodes that is adapted to operate in a useful an efficient manner for achieving a specified goal. In the specific example described above, tracking a given person or person along a path that is covered by the field of view of the specified cameras, forms part of the neighboring data of an originator node.

Those versed in the art will readily understand that the presently disclosed subject matter is not bound to the specific example of object tracking and a fortiori not to the specific example discussed above.

Having described in general certain embodiments of the presently disclosed subject matter, there follows a more detailed discussion with reference to specific Figures. Thus, turning at first to FIG. 1, it illustrates a high level functional block diagram schematically illustrating a network enabling establishing a neighborhood between nodes and allowing communication between nodes, in accordance with certain embodiments of the presently disclosed subject matter. Thus, Network 100 may be any type of communication network. For example communication can be realized over any one of the following networks: the Internet, a local area network (LAN), wide area network (WAN), metropolitan area network (MAN), any type of telephone network (including for example PSTN with DSL technology) or mobile network (including for example GSM, GPRS, CDMA etc.), or any combination thereof. Communication in the network can be realized through any suitable connection (including wired or wireless) and communication technology or standard (WiFi, 3G, LTE, etc).

As illustrated, network 100 comprises several nodes in a network. In communication networks, the definition of a node belonging to the network should be construed to include a computerized device, such as a communication node, that is connected to the network and is capable of generating, receiving, or transmitting information over a communications channel. For example, network 100 comprises child nodes 101A-101D, parent nodes 103A-103B and a grandparent node 105. Child nodes 101A, 101B and 101C are connected to parent node 103A and child node 10th may be connected to parent node 103B. Parent nodes 103A and 103B are both connected to each other, and are themselves child nodes of grandparent node 105. The lines showing the connections in FIG. 1 refer to the physical connections in the network (whether wired or wireless), where the dashed lines refer to logical neighborhood connections. It should be noted that although network 100 illustrates three layers (a layer of a plurality of child nodes, a layer of a plurality of parent nodes and a grandparent node layer), the number of layers should not be considered as limiting, and further layers, including layers of parent nodes, up until a rooting node, may be established.

Each of child nodes 101A-101D can constitute an originator node (also referred to herein as an “originator child node”), a receiving node (“receiving child node” as previously defined), or both. In certain examples, child nodes can be end nodes in a network such as a smart switch or a gateway. Each of child nodes 101A-101D may include a sensor, such as an image acquisition means (e.g., video camera). Further examples of sensors are detailed with respect to FIG. 2. By way of example, all child nodes 101A-101D are located in room 107 (depicted in hashed lines area) in FIG. 1. Each of the child nodes 101A-101D comprises an image acquisition means of a video camera type.

According to certain embodiments of the presently disclosed subject matter, an originator node may generate an event. The generated event can be sensed data obtained by a sensor. For example, each of nodes 101A-101D may constitute an originator node and generate an event, by capturing an image by the video camera. Child node 101A can capture an image with the video camera of an area at the left side of room 107, whereas each of nodes 101B-101D can capture an image of an area by the respective video cameras at the right side of room 107.

Any event generated by each of originator child nodes 101A-101D can be characterized by a characteristic. The event characteristic may be content aware or non-content aware. An example of a content aware characteristic of a generated event may be the image itself as captured by the video camera. Some examples of a non-content aware characteristic of a generated event may be time related, e.g. the time that the event was generated (e.g. the time that the image was captured) or the time that the event was sent to or received by another node in the network. Other examples of a non-content aware characteristic may be unrelated to the generated event, and possibly refer to the originator node itself, such as the type of sensor included in the originator node, the physical location of the originator node, etc. An event may be characterized by more than one characteristic. Each of the characteristics of the event can be content aware or non-content aware, such that an event can have content aware characteristics and non-content aware characteristics concurrently.

For example, the content aware characteristic of an image captured by child node 101B may be the image itself. The associated non-content aware characteristics may be the time that the image was captured, the time that the image was sent from child node 101B to other nodes in the network, etc. Other non-content aware characteristics of the captured imaged event may be the type of the camera included in child node 101B (day/night type camera), the physical location of child node 101B from other child nodes or from a pre-defined location known to the other nodes. For example, child node 101B may generate an event by generating a message of any type, and the non-content aware characteristics of the event will be child node 101B including a day camera.

Consider again the example of originator child node 101B generating an event by capturing an image using its video camera. The generated event is the captured image. After capturing the image, originator child node 101B may send generated event data to its neighboring nodes, e.g. child node 101C, to facilitate processing of the generated event data, e.g. in real time, by neighboring nodes of the originator node. Originator child node 101B may also send generated event data to its parent node, e.g. 103A, for establishing new neighboring relationships to originator child node 101B.

Generated event data is the data relating to the generated event, that originator child node 101B may send to its neighbors and to its parent node, and should be interpreted in a broad manner. The generated event data can include any data relating to the generated event such as the event itself, a copy of the event, a part of the event, a processed version of the event, data related to the event, such as metadata, data relating to the originator of the event such as the originator's ID uniquely identifying the originator node, or any other information that pertains to the originator node. One should note that the generated event data can include one or more of the content and non-content characteristics of the generated event, such as the generation time of the event which is a non-content characteristic of the event, but can also include other data relating to the event, such as a part of the event.

An example of generated event data of a captured image can include for example one or more of the following: a copy of the image, sub-image, capturing time of the image, the ID of the originator node of the captured image, etc.

It should be noted that the generated event data sent to the neighboring nodes is not necessarily identical to the generated event data sent to the parent node, and may include additional, less or different data.

Referring back to originator child node 101B, in order to send generated event data to the neighboring nodes, originator child node 101B may use the neighboring data stored in a data storage associated with originator child node 101B. Based on the neighboring data, originator child node 101B may identify, for example, that child node 101C is a neighbor and to send generated event data, e.g. a copy of the captured image, to child node 101C. Child node 101B may further send a copy of the captured image to other neighbors, based on the stored neighboring data.

In addition to sending generated event data to its neighbors, originator child node 101B can selectively send generated event data to its parent node 103A associated with originator child node 101B, for facilitating association of a new neighboring node to child node 101B. For example, originator child node 101B may send a copy of the captured image to parent node 103A. Alternatively, originator child node 101B may send different data relating to the generated event, than that sent to the neighboring nodes.

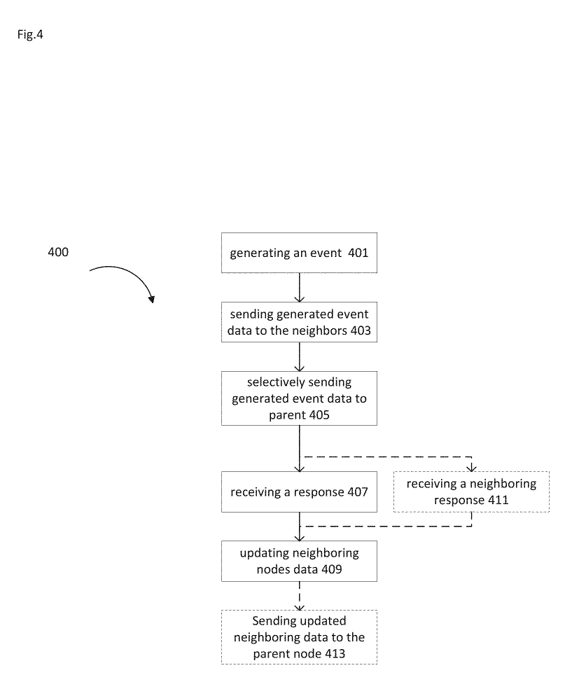

The selective sending of the event data to parent node 103A may be dependent on child node 101B determination, i.e., child node 101B may be configured to determine if a condition is met and if in the affirmative, send the event data to parent node 103A. The condition can e.g. be predefined or dynamically generated. Further description of the selective sending of the generated event data is described in FIG. 4.

If child node 101B determines to send a copy of the captured image to parent node 103A, then parent node 103A may be configured to obtain generated event data originated by child node 101B.

Parent node 103A may then send the generated event data to other nodes in the network. For example, in accordance with certain embodiments, parent node 103A may send the copy of a captured image to its child nodes for the purpose of ascertaining if any of the child nodes should be updated in the neighboring data of the originator node, and be considered as a new neighboring node of the originator node.

Data identifying the child nodes of the parent node (also referred to herein as “child nodes data”) may be stored in a data storage associated with the parent node, and may be used by the parent node in order to identify its child nodes and to send them generated event data. Further details relating to the data storage and child nodes data will be provided with respect to FIG. 3. Based on the child data, parent node 103A may identify, for example, that child node 101A is a child node thereof and to send a copy of the captured image to child node 101A. Parent node 103A may be further configured to send a copy of the captured image to other child nodes, as indicated by the stored child data, such as child node 101B and 101C (or only to selected child node 101C, in case parent node 103A confirms the ID of the node that sent the generated event data to it and does not reply with the same event). As explained above, any receiving child node, such as child nodes 101A, 101B and 101C, may generate by itself a new event, and may subsequently determine, based on the received generated event data, and data relating to the newly generated event, whether a condition has been met. If any of child nodes 101A, 101B and 101C determines that the condition is met, the receiving child nodes may send a response to originator node 101B, and will subsequently be updated in the neighboring data of originator node 101B as a new neighboring node. Further details relating to child nodes 101A, 101B and 101C as receiving nodes determining whether a condition has been met, are described below.

Up till now it was described that originator node 101B may send generated event data to its neighboring nodes (e.g. child node 101C), to facilitate processing of the generated event data by the neighboring nodes, and may also send (identical or different) generated event data to the parent node (e.g. parent node 103A) to facilitate association of new neighboring nodes to the originator node. It was also described that in order to facilitate association of new neighboring nodes to originator child node 101B, parent node 103 may send the generated event data to its child nodes, e.g. 101A, 101B and 101C, where each of the receiving child nodes is a potential new neighboring node of originator child node 101B.

In order to further facilitate association of new neighboring nodes to originator child node 101B, parent node 103A may also distribute the generate event data to other nodes in the network to seek for other potential new neighboring nodes to originator child node 101B. For example, parent node 103A may send the generated event data to its neighboring nodes (also referred to herein as “parent neighboring nodes data”) and to its parent node (also referred to herein as “the grandparent node”).

The data storage associated with parent node 103A may also be configured to store parent neighboring nodes data of parent node 103A. Based on the parent neighboring nodes data, parent node 103A may also send the generated event data to its neighboring nodes, e.g. parent node 103B, for the purpose of ascertaining if any of the child nodes of the parent neighboring nodes should be updated in the neighboring data of the originator child node 101B, and be considered as a new neighboring node of originator child node 101B. Details relating to parent node 103B receiving generated event data and sending it to its respective child nodes, are further described below.

Yet, additionally, parent node 103A may selectively send the generated event data to a grandparent node (e.g. grandparent node 105), constituting a parent node of parent node 103A, and a grandparent node to each one of the child nodes of the parent node (child nodes 101A-101C). Sending the generated event data to grandparent node 105 is for ascertaining if any the descendants of the grandparent node should be updated in the neighboring nodes data of originator child node 101B, and be considered as a new neighboring node of originator child node 101B. The selective sending of the generated event data to the grandparent node may be dependent on the determination of parent node 103A, in a similar way to that described above with respect to child node 101B selectively sending the generated event data to parent node 103A.

Upon receipt of the captured image from parent node 103A, grandparent 105 may send the captured image to its child nodes, e.g. parents 103A and 103B (or only to parent node 103B, in case grandparent node 105 confirms the ID of the node that sent the captured image to it and does not reply with the same event). Sending the captured image to the child nodes of the grandparent nodes (parent nodes 103A and 103B) may be done based on child nodes data stored in a data storage associated with the grandparent node 105, in a similar way to that described with respect to parent node 103A sending the captured image to its child nodes.

As described, parent node 103B can receive generated event data from grandparent 105 sending the captured image to its child nodes (parent nodes 103A and 103B) or, can receive generated event data from parent node 103A, sending the captured image to its neighbors. In both cases, parent node 103B may send the captured image to one or more of its child nodes. In a similar way to that described with respect to parent node 103A, parent node 103B may identify its child nodes based on child nodes data stored in a data storage associated with parent node 103B. Each receiving child node of parent node 103B that receives generated event data may store the generated event data in an associated data storage for future use. Such future use may be for instance upon generation of a new event by the child node, e.g. capturing a new image by the receiving child node, and determining, based on the newly generated event and the stored event, whether a condition has been met. If a condition is met, the child node may send a response to originator child node 101B such that the originator child node 101B may update its neighboring data to include the receiving child node as a new neighbor.

It should be noted that in a hierarchical computerized network comprising a plurality of originator nodes, receiving nodes and parent nodes, a parent node may constitute the parent node in the physical network, of either or both the originator node and the receiving child node. In the latter case, both the originator node and the receiving node constitute child nodes of the parent node (and are also referred to as “originator child node” and “receiving child node” as referred to above).

Up till now it was described that an originator node may generate an event and may send the generated event data to other nodes in the network. For the purpose of establishing new neighboring relationships to the originator node, it was described that an originator node may send the generated event data to the parent node which, in turn, sends the generated event data to its child nodes. The parent node may possibly also send the generated event data to its neighboring nodes (parent neighboring nodes) and its parent node (grandparent node), which further distribute the generated event data to nodes in the network. Eventually, the generated event data is received by a receiving node. Each receiving node is a potential new neighboring node of an originator node.

Referring to the example illustrated in FIG. 1, child node 101A receiving captured image from parent node 103A, that was originated by child node 101B, may be considered as a receiving node. Similarly, child node 101D may also be considered as a receiving node, receiving captured image from parent node 103B (through parent node 103A) that was originated by originator child node 101B. It should be noted that each of parent nodes 103A, 103B as well as grandparent node 105 may constitute a receiving node, in addition to their roles as a parent node and a grandparent node, respectively, which distribute received generated event data to other nodes in the system.

According to certain embodiments of the presently disclosed subject matter, a receiving node, which is a potential new neighboring node of the originator node, may be configured to provide a data storage for storing generated event data, generated by an originator node and received from a parent node that is associated with the receiving node. Each of the receiving child nodes, e.g. 101A and 101D in FIG. 1, may store the received captured image in a respective data storage that may be associated with each of the receiving child nodes 101A and 101D. Further details relating to the data storage will be provided below with respect to FIG. 2.

According to certain embodiments of the presently disclosed subject matter, a receiving node may also be configured to generate a new event and to determine, based on the stored generated event data and data that relates to the newly generated event, whether a condition has been met. If a condition is met, the receiving node may send a response to the originator node. The response is indicative that condition has been met and thereby facilitates the association of the receiving node to the originator node as a new neighboring node. For example, receiving child node 101C may capture a new image. After capturing a new image, receiving child node 101C may also determine, based on the stored copy of the captured image generated by originator node 101B as received from parent node 103A, and data relating to the new captured image, whether a condition has been met. For example, child node 101C may compare the stored image and the newly generated image, using known image processing algorithms, to determine, e.g. whether a person detected in the stored image is also detected in the newly generated image. If the detected person appears in both images, child node 101C may determine that the condition is met and may send a response to child node 101B to inform originator child node 101B that the condition has been met. Upon receipt of a response from receiving child node 101C, originator child node 101B may update its stored neighboring nodes data to include data indicative that child node 101C is a new neighboring node to 101B. Once originator node 101B generates a new second event, originator node 101B may send data relating to the new second event to its neighboring nodes, including child node 101C, which is now a neighboring node.

In some other examples, child node 101A may also capture a new image. Child node 101A may determine, based on the captured image generated by camera 101B as received from parent node 103A, and data relating to the new captured image, that the condition has not been met, for example, since child node 101A did not detect a person in the new image captured by child node 101A. In such examples, child node 101A will not send a response to child node 101B, and will subsequently not be updated as a new neighboring node to 101B.

It should be noted that the receiving node may store the generated event data only until a certain limit condition is met, and once the limit condition is met, the generated event data is deleted or removed. The purpose of limiting the storage period of generated event data received from a parent node is to increase the efficiency of the network, by considering only updated event data received from other nodes in the network, and ignoring data which may be less relevant, or not recent in terms of the time it was generated.

An example of a limit condition may be time-related, i.e., a predefined time interval, measured from the time the generated event data was received or was generated, such that once the time interval passes, the generated event data is deleted. Another example may be a number of events generated by the receiving node, or a number of generated event data received from the parent node, such that once the number of events reaches a predefined threshold, the earliest received generated event data are deleted from the data storage. Those versed in the art will readily appreciate that the presently disclosed subject matter is not limited by the specified limit conditions which are provided for illustrative purposes only.

During the time that received generated event data is stored in the data storage of a receiving node, the receiving node may generate more than one event. In some examples, after generation of each new event by the receiving node, the receiving node may determine, based on the stored generated event data and data relating to the newly generated event, whether a condition has been met. In some cases, where the receiving node generates more than one event, it can determine, based on the stored generated event data and data relating to the new earlier generated event, that the condition is not met, whereas, when determining, based on the stored generated event data and data relating to a new later generated event, that the condition is met. The reason is that several factors may affect the generation of the events at the receiving node's end, thus also affecting determination of the receiving node whether or not a condition has been met.

In order to exemplify such cases, reference is made back to the copy of image originated by child node 101B and eventually received and stored in receiving child node 101D. Receiving child node 101D may capture more than one image during the time that the received captured image is stored, and may determine, every time, after capturing a new image, whether a condition has been met. Such determination may constitute by comparing each new captured image to the stored captured image. If any one of the new captured images and the stored image meet a condition, for example, the same person is detected in both images, receiving child node 101D may send a response to originator child node 101B indicative of meeting the condition. Subsequently, child node 101D will be updated in the neighboring data of originator child node 101B.

Below are two examples of factors which may affect the captured images by receiving child node 101D. The first example is a physical change in the area, e.g. opening and closing of a door. The second example relates to the quality of images generated by receiving child node 101D.

In the first example of a physical change in the area, consider a door that was opened and therefore blocked the view of receiving child node 101D towards a certain point of interest. In such an example, child nodes 101B and 101D capture different fields of view of the same point, thereby providing a Line of Sight (LOS) to the point of interest, notwithstanding the elimination of the LOS to the point by receiving child node 101D. After closing the door and removing the blocked sight, child nodes 101B and 101D once again have a clear LOS with unobstructed vision of the point of interest. Assuming, for example, that child node 101B generated an event by capturing an image including the face of a person. A copy of the image was eventually (through the involved parent nodes) received by child node 101D. Receiving child node 101D received and stored the image in the data storage associated with receiving child node 101D. Assume also, that a door was opened and then closed, thus blocking the LOS of child node 101D of room 107 (or a part of room 107) for a certain period of time, as described above. Child node 101D may generate two (or more) events, by capturing images. The first image was captured while the door was opened and includes an image of the door. The second image was captured while the door was closed and includes a LOS of the room. Thus, upon comparing the stored image and the newly generated first image, to determine whether a condition has been met, e.g. whether the first image also includes the face detected by the stored image, child node 101D will determine that the condition has not been met and will not send any response to originator child node 101B. On the other hand, upon comparing the second generated image to the stored image, child node 101D may detect the same face in the second generated image, and thus determine that the condition is met, in which case, child node 101D will send a response to originator child node 101B, which will result in originator child node 101B updating its neighboring data to include data relating to child node 101D.

In the second example of quality of images generated by the receiving node, consider lighting conditions that adversely affect the quality of the captured image. In such a case, the first newly generated image by receiving child node 101D was blurred, and hence, the there was no similarity to the stored received image, namely it was impossible to identify the face of the same person in the stored image and the newly generated image, and hence, the condition was not met. However, in the next captured image, the face was detected in a clearer manner (due to improved ambient lighting conditions), resulting in similarity between the second newly generated image and the stored image, thus enabling receiving child node 101D to determine that the condition is met, and to send a response to originator child node 101B, such that originator child node 101B will update its neighboring data to include receiving child node 101D.

Note that the invention is not bound by the specific example illustrated above with respect to various embodiments of the presently disclosed subject matter. Moreover, for efficiency purposes, a receiving child node may determine when to inspect whether a condition has been met, and does not automatically inspect whether a condition has been met after generation of every new event. For example, a receiving node may inspect whether a condition has been met e.g. every pre-defined number of newly generated events, or e.g. every pre-defined period of time, etc.

With reference to FIG. 1, it may be noted that network 100 is a general schematic illustration and any one of child nodes 101A-101D may be connected to multiple other child nodes, via one or more parent nodes, and one or more grandparent nodes.

Turning now to FIG. 2, it illustrates an example of a functional block diagram of a node in the network, in accordance with certain embodiments of the presently disclosed subject matter. Node 200 can have the role of an originator node (e.g. child node 101B in FIG. 1) and/or a receiving node (e.g. child node 101D in FIG. 1) and includes one or more processors 201 and a computer memory-data storage 205 (including non-transitory computer memory and possibly also transitory computer memory). Node 200 may include a communication unit 207, facilitating communication of the node with other nodes in the network (e.g. via LAN, Internet, cellular network, etc).

Node 200 may further include one or more sensors 203, enabling to generate an event by obtaining sensed data. Examples of sensor 203 may include any one of an image acquisition means (e.g. video camera), an audio acquisition means (e.g. speaker), license plate recognition (LPR) means and motion detection means.

As mentioned, an event generated e.g. by a sensor, may have one or more content and non-content aware characteristics. Considering the above illustrated sensors, following are some examples of content aware characteristics of an event generated by the exemplified sensors: considering a sensor being a video camera, the generated event may be an image, while the content aware characteristics of the captured image may be the content of the image (e.g., a person detected in the image); considering a sensor being license plate recognition (LPR) means, the generated event may be the license plate captured by LPR means, while the content aware characteristic of the captured license plate is the number of the license plate itself; considering a sensor being an audio acquisition means, the generated event may be an audio recording, while the content aware characteristics of the audio may be the content of the audio recording; and considering a sensor being motion detection means, the generated event may be the motion captured by the motion detection means, while the content aware characteristics of the motion may be the change in the position of the detected object relative to its surroundings.

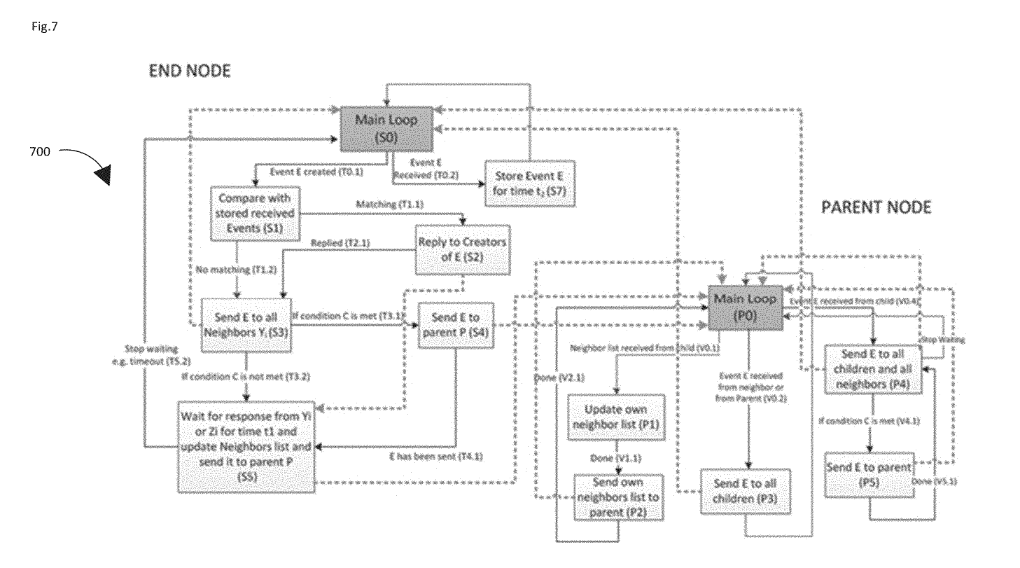

It should be noted that node 200 may generate an event, e.g. using the sensor 203, when acting as an originator node, or when acting as a receiving node, or both, as exemplified above and will further be described with respect to FIG. 7.

Data storage 205 included in node 200 is configured to store generated event data 209 and parent node data 211. Parent node data 211 can include data identifying a parent node associated with node 200, e.g. by storing the ID of the parent node. Generated event data 209 can include data relating to one or more events generated by one or more originator nodes, and received from the parent node (e.g. parent node data 211). As mentioned, data relating to each of the events stored in generated event data 209 may be stored until a certain limit condition is met. Once the limit condition is met, the data relating to a specific event data may be deleted or removed.

Data storage 205 can also store neighboring nodes data 213. Neighboring nodes data 213 includes neighboring data indicative of the neighboring nodes of node 200. The neighboring data can relate to one or more neighboring nodes. According to a non-limiting example, neighboring nodes data 213 can be in the form of a list of one or more neighboring nodes of node 200, identified by their unique IDs. Update to neighboring nodes data 213 can be carried out e.g. by neighborhood handler 215, which is optionally also stored in data storage 205. For example, consider node 200, acting as an originator node. Node 200 may originate an event and send it to other nodes in the network, using the parent node (e.g. parent node data 211). Originator node 200 may receive a response, that was originated by another node in the network, of meeting a condition (i.e., the other node is a new neighboring node of originator node 200, after the other node determined that the condition was met based on the generated event data sent from originator node 200 and a new event generated by the other node). Neighborhood handler 215 may then update neighboring nodes data 213 to refer to the other node that originated the response by adding its ID into the list.

Neighborhood handler 215 can also update neighboring nodes data 213 by removing neighboring data that pertains to a specific neighboring node, e.g. by removing the ID of the node from the list, or by associating a node with a “trash” class as explained further below, if a removal criterion is met. The removal of a neighboring node can be a physical removal (e.g. by deleting data relating to the neighboring node from neighboring nodes data 213), or a logical removal (e.g. by changing the class associated with the neighboring node to be a trash class, such that data relating to the node is stored, however, the neighboring node is no longer associated as a neighbor to originator node 200).

A removal criterion can be met, for example, if any of the following occurs: no response is received from the neighboring node after originator node 200 sends one or more generated event data to a neighboring node during a certain time, if a response is received from the neighboring node, however, the response time exceeding a given time duration, if the physical distance between node 200 and the neighboring node exceeds a certain distance. Other examples of a removal criterion can be used for determining that a certain neighboring node has to be removed from the neighboring nodes data 213. It should be noted that the term “criterion” as used herein should be expansively construed to include any compound criterion, including, for example, several criteria and/or their logical combinations.

In some examples, neighborhood handler 215 can also update neighboring nodes data 213 by adding data relating to neighboring nodes of stored neighboring nodes. In such examples, node 200 can receive neighboring nodes data of one of its neighbors, say neighboring node A, and update neighboring nodes data 213 to include a part or all of the neighboring nodes data of neighboring node A. After generating a new event, node 200 may send data relating to the new event to all of its neighboring nodes, which include also some or all of the neighbors of node A.

Neighboring nodes data 213 includes neighboring data indicative of the neighboring nodes of node 200, where the neighboring data can relate to one or more neighboring nodes. According to certain embodiments of the presently disclosed subject matter, some or all of the neighboring nodes are associated with a class. A class can characterize the neighborhood relationship between the neighboring node and originator node 200. The class of neighborhood relationship may be determined e.g., based on characteristics of the communication between the nodes. One example of characteristics of communication between the nodes is the time duration that has elapsed from the time that generated event data was sent from an originator node to a neighboring node until a response was received from the neighboring node. If the time duration is short, e.g. less than a predefined threshold time, the neighboring node will be ranked with a high class, whereas if the time duration is long, e.g. longer than a predefined threshold time, the neighboring node will be ranked with a lower class (in certain cases, long time duration to receive a response from a neighboring node may result in a removal of the neighboring node from neighboring nodes data 213, as described above, or in determining that the class associated with the neighboring node is a “trash” class, which may represent, for example, a node which was previously associated as a neighboring node to node 200 and optionally was also previously associated with a higher class, as also detailed above. Further examples of characteristics of communication between the nodes are described below.

In some examples, more than two classes may be utilized for characterizing the neighborhood relationship between the neighboring node and originator node 200. For instance, a range including three classes can include a low class, a middle class and a high class.

According to certain embodiments of the presently disclosed subject matter the classes can be used by originator node 200 to send at least partially different generated event data to its neighboring nodes, based on their classes. For example, node 200 can send to a neighboring node, associated with a high class, generated event data of a certain type, such as a full copy of a captured image, and to a different neighboring node, associated with a low class, different generated event data, such as a sub-image of the captured image. In order to exemplify the above classes, reference is made again to FIG. 1, and to originator child node 101B (being in this example node 200) that may capture an image. Originator childe node 101B may send a full copy of the captured image, which includes the face of a person, to child node 101C, associated with a high class, and send only a sub-image of the captured image, such as a general contour of a face, to child node 101A, associated with a lower class.

Referring back to FIG. 2 and to data storage 205 storing neighboring nodes data 213, then neighboring nodes data 213 may include data relating to the class associated with each of the neighboring nodes.

Reverting to node 200 in FIG. 2, being an originator node, after originator node 200 sends generated event data to its neighboring nodes, originator node 200 may receive a neighboring response from one or more of its neighboring nodes. The response can be e.g. an acknowledgement of receiving the generated event data. The neighboring response can be characterized by response characteristics. Examples of response characteristics can include one or more of the following examples: duration of time to receive the neighboring response from the time that the generated event was sent from the originator node, number of responses previously received from the neighboring node, a physical distance from the originator node, etc.

Depending on the characteristics of the response received from the neighboring node, originator node 200 can update the class associated with that neighboring node. For example, if the response time of the neighboring response exceeds a given time duration, then originator node 200 can update the class of the neighboring node to be of a lower class (e.g. associate a low class to that neighboring node). The opposite may also apply. If the response time of the neighboring response is less than a given time duration, then originator node 200 can update the class of the neighboring node to be of a higher class (e.g. associate a high class to that neighboring node). Another example may be the number of responses previously received from the neighboring node. For instance, the higher the number of responses (when compared to a threshold, or relatively to other neighboring nodes), the higher the class that is associated with the neighboring node. Yet another example may be the physical distance of the neighboring node from originator node 200. In a similar way, the closer the neighboring node location, the higher the class that is associated with the neighboring node. One should note that originator node 200 may consider more than one response characteristic in order to determine whether or not a class associated with a neighboring node should be updated.

According to certain embodiments of the presently disclosed subject matter, the initial update of neighboring nodes data 213 to include data related to a new neighboring node can also include updating a class associated with the new neighboring node as one of the defined classes. Similar response characteristics used for characterizing a neighboring response can also be used for characterizing the response from the new neighboring node, e.g. the duration of time to receive the response from the new neighboring node, the physical distance from the originator node, etc. The class can later be further updated depending on future responses received from the new neighboring node (which will be considered as neighboring responses).

The update of the class to an existing neighboring node or to a new neighboring node in neighboring nodes data 213 can be carried out e.g. by neighborhood handler 215. For example, upon receipt of a response at originator node 200, neighborhood handler 215 can analyze the response to determine whether a response is a neighboring response, i.e. from an existing neighboring node, or whether the response is from a new neighboring node. For example, neighborhood handler 215 can extract the ID of the originator of the response, and compare the ID with current IDs of neighboring nodes in neighboring nodes data 213. Another example is to use different tokens for sending generated event data from the originator node to neighboring nodes and for sending generated event data to its parent node for associating new neighboring nodes with the originator node. Any response should include the token that was used by the originator node in the generated event data sent by it. In some cases, neighborhood handler 215 can determine that no update is required to the class of the neighboring node, e.g. if the characteristics of the neighboring response match the current class of the neighboring node.

As mentioned, neighboring nodes data 213 includes neighboring data indicative of the neighboring nodes of originator node 200, where the neighboring data can relate to one or more neighboring nodes. According to certain embodiments of the presently disclosed subject matter, some or all of the neighboring nodes are associated with a group. In some examples, a neighboring node can be associated with more than one group. Based on the group(s) associated with the neighboring nodes, originator node 200 may send the generated event data to a neighboring node which is associated with, say certain group A, and not sending the generated event data to any neighboring nodes which are not associated with group A. Further details relating to sending event data to neighboring nodes associated with a group are detailed below.

According to certain embodiments of the presently disclosed subject matter, there may be more than one type of neighborhood relationship between nodes in the network. The type can be e.g. based on the event used to associate a receiving node to an originator node as a new neighboring node. Accordingly, some or all of the neighboring nodes may be associated with a certain type of neighborhood relationship. For example, reverting back to the example of an event data being a copy of a captured image including a face, a receiving node A can be neighbor of originator node 200 due to detecting the same face. Simultaneously, a receiving node B can be neighbor of originator node 200 due to including the same sensor type, e.g. day camera. In such an example, originator node 200 may have two or more types of neighborhood relationships, one type associated with receiving node A (and possibly other neighboring nodes, e.g. receiving nodes detected the same face) and another type associated with receiving node B (and possibly other neighboring nodes, e.g. receiving nodes including the same sensor type). According to certain embodiments of the presently disclosed subject matter, neighboring nodes associated with different types of neighborhood relationships are not necessarily neighbors of each other. For example, node B and node A may not be neighboring nodes of each other.

Data storage 205 can also store a function data 217. Function data 217 can include one or more functions. Each function is indicative of how to determine whether a condition is met in order to determine whether a receiving node is a neighboring node of an originator node. In some cases, a function can relate to the characteristic of the event.

The utilization of the function will now be explained for instance in the context of content aware characteristic of events discussed above. Consider for example content aware events being captured images. Moving on with this example, in order to determine whether a receiving node (e.g. node 200) is a neighboring node of an originating node, a similarity criterion function (being a non-limiting example of a function) is applied to (i) the event data (i.e. images) that have been received and stored at the receiving node 200) and (ii) a new event data generated at the receiving node (e.g. a new image acquired by the image acquisition means of the receiving node 200). Note that a similarity criterion between two or more images can relate to the degree of similarity between the images, as computed using known per se techniques.

Another example of a similarity criterion function may be related to license plate recognition. Consider for example content aware events being captured as license plates. A similarity criterion function is applied to (i) the event data (i.e. license plate) that have been received and stored at the receiving node 200) and (ii) new event data generated at the receiving node (e.g. a new license plate acquired by the license plate recognition (LPR) means of the receiving node 200). In such an example, a similarity criterion between two or more license plates can be based on e.g. a text comparison of license plates, where a condition may be determined to be met, if e.g. the text comparison results in finding identical license plates, or license plates pertaining to the same city, etc. If node 200 determines that the similarity criterion function is met, e.g. that the so generated image and at least one of the so stored images are identical or similar to a certain degree, or if finding identical license plates (as prescribed by the similarity criterion function), then receiving node 200 can send a response to the originator node, to inform of meeting the similarity criterion. Upon receiving the response, the originator node may update its neighboring data to include receiving node 200.

Note that the specified similarity criterion is only an example of a function that may be applied in the context of content aware characteristics and the presently disclosed subject matter is not bound by this example.

Moving forward to non-content aware characteristics of an event, various examples exist to functions which are indicative of how to determine whether a condition is met. In some cases a function can be characterized by time. For example, a time interval can be predefined, e.g. 60 seconds. A function can indicate that the condition is met for any event that is received every 60 seconds. In such cases, receiving node 200 can generate any event e.g. an acknowledgment (ACK) message, and send a response with the ACK to the originator node of the event.

Other examples of functions that can be characterized by time are functions that relate to the time tag of the stored generated event data. The time tag can represent e.g. the time that an event was generated. The time tag can also represent the time that an event was sent from the originator node. In some of the examples a function can indicate that a condition is met, if a certain period of time has not elapsed between the time that the stored generated event data was generated (or sent) by the originator node and the time that the new event was generated by receiving node 200.

Functions characterized by time are examples of functions in cases of events being characterized by non-content aware characteristics. Additional examples of functions in cases of a non-content aware characteristic of an event can relate to characteristics of the originator node, for example, the number of hops (or the physical distance) between the originator node and node 200. A function can indicate that the condition is met, if the number of hops (or the physical distance) between the originator node and receiving node 200 is not larger than a given threshold.

Other examples of functions for determining whether a condition has been met in case of events being characterized by non-content aware characteristic may relate to characteristics of the nodes themselves. For example, a function can indicate that the condition is met, if one or both of the originator node and receiving node 200 includes a certain type of sensor (such as a day/night camera). A function can indicate that the condition is met, if the originator node is located in a certain pre-defined geographical area. Those versed in the art will readily appreciate the presently disclosed subject matter is not limited by the specified functions which are provided for illustrative purposes only.

In some cases, a function can be a complex function which is comprised of more than one function exemplified above. For example, in order to determine that the condition is met, both similarity criteria relating to content characteristics of two images should be checked, as well as a function relating to characteristics of the originator node, or the time difference between the captured time of the images.

In yet some cases, function data 217 comprises more than one function, such that at each event, receiving node 200 should determine which of the functions should be selected and checked, in order to determine whether a condition is met. In some examples, the stored generated event data is indicative of which function should be selected from the function data 217.

According to certain embodiments of the presently disclosed subject matter, a function can be characterized by a predefined sequence of events. In such a case, receiving node 200 can store any event it receives from an originator node and further stores any event that is generated by receiving node 200. The received and generated events can be stored sequentially to form a stored sequence of events. The sequence can be ordered by a generation time tag representing the time that the event was generated. Alternatively, the sequence can be ordered by receiving time tag representing the time that the event was received at receiving node 200. Other types of time tags can be used for determining the order of the events.

Receiving node 200 can determine at any stage that the condition is met if the stored sequence of events fulfills the function characteristics of a predefined sequence of events. In such cases, node 200 can inform the originator node which originated the first event in the sequence, that the condition is met, such that the originator node may update its neighboring data to include receiving node 200.

To illustrate a function that is characterized by a predefined sequence of events, reference is made to the following example of a predefined sequence of events including the following events of a person entering a building and switching on the lights, where the events are images captured by a camera:

Event (image) a: a person enters a building;

Event (image) b: lights are switched on.

Considering receiving node 200 receives the following events from an originator node, and possibly also from another node in the network:

Image a originated a by originator node a: door opened;

Image b originated by originator node b: a person enters a building;

Image c captured by receiving node 200: lights are switched on.

After capturing image c, receiving node 200 can determine that the condition is met (based on images b and c) and send a response to originator node b that the condition is met. Originator node b will update its neighboring node data to include data relating to receiving node 200.

In some cases, the stored sequence of events can include some or all of the events generated by the originator node, as well as additional events generated by other nodes in the network. In such cases, the stored sequence of events includes two events or more, where the first event is received at receiving node 200 from an originator node and one or more of the other events in the sequence are also received from the originator node, whereas the remaining events in the sequence (if any) are received at receiving node 200 from one or more nodes of the network (other than the originator). Alternatively, all the other events in the sequence (apart from the first event) are received at receiving node 200 by one or more nodes of the networks (other than the originator).

In some cases, each function can be characterized by more than one predefined sequence of events, such that receiving node 200 can inspect some or all of the predefined sequence of events to determine whether a condition has been met with respect to one of the stored sequence of events. As described, in some examples, node 200 can determine when to inspect whether a stored sequence of events fulfills the function characteristics of the sequence of events. For example, receiving node 200 can determine to check the stored sequence of events every time after receiving node 200 generates a new event, or after every period of time has passed. Other rules can also be applied for determining when to perform an inspection.

In some examples, the function is further characterized by a particular originator node associated with each of the events in the predefined sequence of events, such that the function indicates both which event should occur, and which node should generate the event. Any node can be associated with more than one event in the sequence.

In addition or alternative to each event being associated with a particular node, each event can be associated with a time tag, such that the function can be characterized by a time tag associated with each event of the sequence of events. The time tag can be representative of a time interval during which an event should be generated or received, or can be any definition of a time that can be associated with an event. In order to meet the function characteristics of a predefined sequence of events in this case, storing the generated event data can also be based on the time tag associated with received generated event data or newly generated events.

In some examples the function may apply to more than one predefined sequence of events, and the predefined sequences of events can be represented as a state machine. Each state in the state machine can represent an event of the predefined sequence of events. A copy of the state machine or any representation thereof can be stored in each node in the network, such that receiving node 200 can process any received and generated events against the state machine, in order to ascertain whether a sequence or sequences of events received from the originator and/or other nodes of the network (as explained above) results in a finite state of the state machine, thereby indicating that a condition is met, in which case receiving node 200 will eventually be updated in the neighboring node data of the originator node.

Note that the presently disclosed subject matter is not bound by the specified examples of functions and or sequence (or sequences) of events, all of which have been exemplified for illustrative purposes only.

Reference now is made to FIG. 3, illustrating an example of a functional block diagram of a parent node, in accordance with certain embodiments of the presently disclosed subject matter.

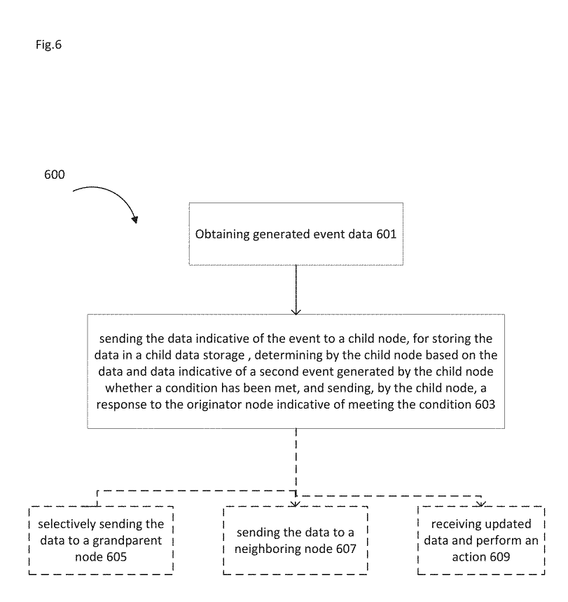

FIG. 3 illustrates a parent node 300, data of which can be stored e.g. in parent node data 211 illustrated in FIG. 2. Parent node 300 can obtain generated event data generated by an originator node in the network and distribute by sending the generated event data to other nodes in the network. Sending generated event data to other nodes in the system facilitates association of new neighbors to the originator node of the event (in case a condition is met at the receiving node's end). Further details relating to parent node 300 obtaining or sending data to other nodes is discussed in FIG. 6. It should be noted that a node in the network can have the role of a parent node, in terms of facilitating association of new neighbors to the originator node of the event, and concurrently constitutes also an originator and/or a receiving node in terms of generating or receiving events from other nodes.

Parent node 300 may include one or more processors 301 and a computer memory-data storage 305 (including non-transitory computer memory and possibly also transitory computer memory). Parent node 300 may include a communication unit 307, facilitating communication of the node with other nodes in the network (e.g. via LAN, Internet, cellular network, etc).

Parent node 300 may include one or more sensors 303, enabling to obtain sensed data.

Data storage 305 is configured to store generated event data 309 and parent node data 311. Parent node data 311 can include data identifying a parent node associated with parent node 300, e.g. by storing the ID of the parent node. Generated event data 309 can include data relating to one or more events, generated by one or more originator nodes, and received from the parent node (e.g. parent node data 311).

Data storage 305 can also include neighboring nodes data 313. Neighboring nodes data 313 includes neighboring data indicative of the neighboring nodes of parent node 300. The neighboring data can relate to one or more neighboring nodes. Update to neighboring nodes data 313 can be carried out e.g. by neighborhood handler 315, which is optionally also stored in data storage 305. In addition, data storage 305 can also include function data 317.

Components 301, 303, 309, 311, 313, 315 and 317 correspond to components 201, 203, 209, 211, 213, 215 and 217 of node 200 illustrated in FIG. 2, respectively, and can be considered as similar in functionality and features in parent node 300.

Further to the above, parent node 300 can include child nodes data 319. Child nodes data 319 includes child data indicative of the child nodes of parent node 300 (e.g. node 200 illustrated in FIG. 2). The child data can relate to one or more child nodes. According to a non-limiting example, child nodes data 319 can be in the form of a list of one or more child nodes of parent node 300, identified by their IDs.

According to certain embodiments of the presently disclosed subject matter, child nodes data 319 can further include child neighboring node data, meaning, for each child node, child nodes data 319 also includes data indicative of the neighboring nodes associated with each child node, respectively. Additionally, for each neighboring node of each of the child nodes, data relating to the respective parent node can also be included in child nodes data 319.

In some examples, parent node 300 can receive updates to the data included in child nodes data 319 and continuously update stored child nodes data 319, accordingly. In some cases, parent node 300 can selectively update stored child nodes data 319 by determining if and when to update the stored data. The selective updating of the child neighboring node data is further discussed in relation to FIG. 6.

Each of data storages 205 and 305 illustrated in FIG. 2 and FIG. 3 can form an integral part of node 200 and parent node 300, respectively, or be configured (partially or wholly) in separate storage units connected over a network communication link to node 200 and parent node 300. Furthermore, data storages 205 and 305 can be configured in different storage units (e.g. different storage servers). Alternatively, data storages 205 and 305 can be consolidated in a single storage unit. Data storages 205 and 305 can be implemented as designated database servers. Note that the presently disclosed subject matter is not bound by these examples.

FIGS. 1-3 illustrate a general schematic of the system and nodes architecture in accordance with an embodiment of the presently disclosed subject matter. The modules and components in FIGS. 1-3 may be centralized in one location or dispersed over more than one location. In other embodiments of the presently disclosed subject matter, the system and nodes may comprise fewer, more, and/or different modules/entities than those shown in FIGS. 1-3.

Turning now to FIG. 4, this illustrates a flowchart 400 exemplifying operations that are carried out at the originator node side, in accordance with the presently disclosed subject matter. Operations described with reference to FIG. 4 can be performed for example by node 200 (FIG. 2), having the role of an originator node.

Consider for example that node 200 generates an event, and wishes to send it to other nodes in the network (e.g. network 100 in FIG. 1). Assuming, for the sake of example only, that node 200 generates the event by capturing an image using a camera (block 401).

In some cases, generating an event can be triggered by an internal or external occurrence, such as receiving event data from another neighboring node. Another example of an occurrence which may trigger a node to generate an event is a timer, or a sensor device. For example, a timer can be simple clock device issuing a “tick” e.g. once a second, causing e.g. a connected camera to take a picture. Another example is a sensor device that can be a motion detector issuing a signal upon motion detection, causing e.g. a connected camera to take a picture. Note that the invention is not bound by the specific example illustrated above with respect of various embodiments of the presently disclosed subject matter.

The captured image includes the face of a person. Node 200 sends data relating to the captured image (generated event data) to one of its neighbors (block 403). Node 200 can also send data relating to the captured image to more than one neighboring node, or to all of its neighboring nodes (e.g. using the data included in neighboring nodes data 213). As explained with reference to FIG. 2, the neighboring nodes of node 200 can be associated with one or more groups. Therefore, node 200 may send generated event data to neighboring nodes associated with one or more groups according to a given group criterion. For example, a group can be characterized by a certain sensor type, such that all members (nodes) belonging to that group include the certain sensor type. Node 200 can determine to send the generated event to all members belonging to the group characterized by the certain sensor type.

Additionally or alternatively, as also described above with respect to FIG. 2, the neighboring nodes of originator node 200 can be associated with a certain type of neighborhood relationship. Therefore, originator node 200 may send generated event data to neighboring nodes associated with a certain type of neighborhood relationship. For example, a certain type of neighborhood relationship, e.g. the type of event based on which the neighboring nodes were associated as neighbors to originator node 200, may be defined. Originator node 200 can determine to send the generated event to all members associated with the certain type of neighborhood relationship.

Note that the invention is not bound by the specific example illustrated above with respect to various embodiments of the presently disclosed subject matter.

Generated event data 209 described with respect to FIG. 2 refers to data relating to one or more events, generated by one or more originator nodes. As described above, each neighboring node may be associated with a class.

According to certain embodiments of the presently disclosed subject matter the classes can be used by node 200 to send different generated event data to its neighboring nodes, based on their classes. Thus, by way of example, referring back to block 402 in FIG. 4, node 200 can capture an image and send a full copy of the captured image which includes the face of a person, to neighboring node A, associated with a high class, and sends only a sub-image of the captured image, such as a general contour of a face, to neighboring node B, associated with a lower class.

It should be noted that a generated event can be characterized by content aware/non-content aware characteristics, as discussed above.

Moving on with this example, after node 200 sends data relating to the captured image to one or more of its neighbors, nodes 200 may selectively send generated event data to a parent node (block 405), e.g. based on parent node data 211. Sending generated event data to the parent node is for facilitating association of a new neighboring node to node 200, which, as mentioned above, has the role of an originator node. In some examples, the generated event data sent to the parent node is identical to the generated event data sent to the neighbors of node 200. In some other examples, the event data sent to the parent node is partially identical, includes more or less details than the generated event data sent to the neighbors of node 200, or can be completely different data of the generated event.

The selective sending of the event data to the parent node can be dependent on the determination of node 200, i.e., node 200 is configured to determine if a sending condition is met and if the sending condition is met, to send the generated event data to the parent node. According to certain embodiments of the presently disclosed subject matter, this can be e.g. predefined or dynamically determined. For example, after capturing an image, node 200 is configured to determine whether a given time interval has passed, since sending a previous generated event data to the parent node. If so, node 200 can determine to send the captured image to the parent node. Various examples exist for conditions which can be used for determining whether to send the event data to the parent node, such as if, after sending a previous generated event data to the parent node, a random time has elapsed, if after sending a previous generated event data to the parent node a number of events that were generated by the originator node exceed a predefined (or random) value. Those versed in the art will readily appreciate that the presently disclosed subject matter is not bound by these examples.

A receiving node, receiving the generated event data, can send a response to the originator node, to inform the originator node that a condition has been met. Hence, the node 200 having the role of an originator node, can receive a response (block 407) from a new neighboring node, and can update the neighboring nodes data to include the new neighbor (block 409).

In some examples, the response from a new neighboring node may be limited to fall within a given time interval, such that if a response may not received within a certain time duration, or if a response may be received after the specified time interval has elapsed, the receiving node originating the response will not be updated as a new neighboring node to originator node 200. Upon generation of a further event by originator node 200, originator node 200 may send generated event data to its neighboring nodes, including any new neighboring nodes which were recently updated.

The update of the neighboring nodes data in block 409 can be carried out e.g. by updating data indicative of the new neighboring node to neighboring node data 213, by neighborhood handler 215, illustrated in FIG. 2.

In some examples, in addition to receiving a response from a new neighboring node, (originator) node 200 can receive a neighboring response, from one of its neighbors, in response to sending the generated event data to them (block 411). The response can e.g. be an acknowledgement of receiving the generated event data from node 200.

As explained above with respect to FIG. 2, both the response from the new neighboring node and the neighboring response from the neighboring node can be characterized by response characteristics (as detailed above, one example of a characteristic can be duration of time to receive the neighboring response, from the time that the generated event was sent from the originator node).

As also explained with respect to the originator's neighboring nodes, each of the neighboring nodes can be associated with a class. Hence, depending on characteristics of the response, either from a new neighboring node, or from an existing neighboring node, node 200 can update, in block 409, also the class associated with a node. The update of the neighboring node data is continuous and may increase the accuracy of the neighborhood relationship between nodes. Further details regarding characteristics of the response and the update based on the characteristics were described with respect to FIG. 2 above.

It should be noted that known per se networks may assume a bi-directional relationship between nodes and share information based on such assumptions, whereas in some cases, a certain direction of path for passing information does not necessarily mean that the opposite direction of passing information is beneficial, or even necessary.

It should be noted that, according to certain embodiments of the presently disclosed subject matter, the neighborhood relationships between nodes are not necessarily bi-directional, as neighboring nodes are defined for each node in the network, in an independent and asymmetric way with respect to other nodes in the network. Thus, if a given node is a neighbor of an originator node, the originator node is not necessarily a neighbor of the given node. Reverting to block 409 in FIG. 4, the fact that node 200 updates neighboring nodes data 213 to include data relating to a new neighboring node does not entail that data relating to node 200 is added or exists in the neighboring data associated with the new neighboring node.

In accordance with certain embodiments, after updating neighboring nodes data 213, nodes 200 can send the updated neighboring nodes data 213 to the parent node, e.g. based on parent node data 211 (block 413). In some examples, node 200 can send only a part of the updated neighboring nodes data 213 to the parent node, e.g. only the part of neighboring nodes data 213 which was updated, or which was substantially updated.

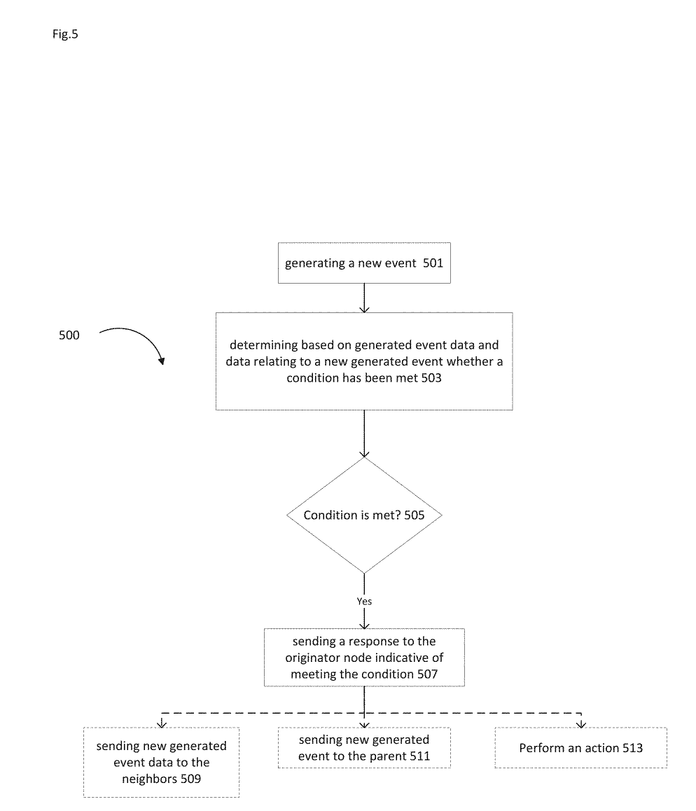

Turning now to FIG. 5, it illustrates a flowchart 500 exemplifying operations which are carried out at the receiving node side, in accordance with the presently disclosed subject matter. The operations described with reference to FIG. 5 can be performed for example by the same node 200, which can have the role of an originator node as illustrated with respect to FIG. 4, but now, additionally or alternatively, also has a role of a receiving node which receives generated event data from other originator nodes.

Consider for example, that node 200 generates a new event (block 501) by e.g. capturing an image using a camera.

In some cases, generating an event can be triggered by an internal or external occurrence. The examples provided above with respect to block 401 in FIG. 4 are also applicable with respect to block 501.

Based on generated event data e.g. included in generated event data 209, and data relating to the newly generated event, node 200 can determine whether a condition has been met (block 503).

It should be noted that the stored generated event data can include data relating to more than one event generated by one or more originator nodes. Hence, in some examples, node 200 can determine, based on the data relating to each of the different generated events, and the data relating to the newly generated event, whether a condition has been met. For example, if data relating to two generated events, e.g. events A and B, is included in generated event data 209, node 200 can determine, based on the stored data relating to generated event A and data relating to the newly generated event, that the condition is met, while determining, based on the stored data relating to generated event B and data relating to the newly generated event, that the condition is not met.

Each of the stored generated event data received from other originator nodes, and the newly generated event can be characterized by a content aware or non-content aware event characteristic. The description provided above with respect to content aware and non-content aware events with reference to FIG. 1 is also applicable with respect to FIG. 5. Thus, in order to determine whether a condition is met, node 200 can use one or more of the functions stored in function data 217. A non-limiting example of a function is a similarity criterion, such that the similarity criterion between two or more images can relate to the degree of similarity between the images, as computed using known per se techniques. Hence, node 200 can determine that the condition is met, if two captured images, e.g. the newly generated image by node 200 and the stored image received from another originator, are similar to a certain degree. Details regarding functions and similar criterion function were described above with respect to FIG. 2.

If node 200 (which, as mentioned, has the role of a receiving node) determines that the condition is met (block 505), node 200 may send a response to the originator node, which generated the stored imaged. The response to the originator node is indicative of meeting the condition, thereby facilitating the association of receiving node 200 to the originator node, as a new neighboring node of the originator node (block 507). Upon receipt of the response, the originator node can update its neighboring node data to include data relating to node 200.

According to some examples, node 200 can also have the role of an originator with respect to its newly generated event. Similar to what has been described with reference to FIG. 2 above, the data storage associated with node 200 is further configured to store neighboring nodes data indicative of the neighboring nodes of node 200 (e.g. neighboring nodes data 213 stored in data storage 205). Hence, node 200 can send newly generated event data, relating to the newly generated event, to one or more of its neighboring nodes (block 509), for facilitating processing of the newly generated event data by a processor of each one of the receiving neighboring nodes.

In addition or alternatively, node 200 can also selectively send data relating to the newly generated event to the parent node (e.g. based on parent node data 211), for facilitating the association of a new neighboring node to node 200 (block 511). The description above (with reference to FIG. 1) of the selective sending of the event data to a parent node is also applicable herein with respect to node 200 being both a receiver node and an originator node.

Reverting to node 200 in its capacity as a receiving node, it can also perform an action based on the events which are received from other originator node(s) and stored in generated event data 209, or data relating to the newly generated event (block 513). The action can be carried out utilizing the stored or generated event data. Moreover, the fact that the condition has been met, i.e., that node 200 is a neighbor of another originator node, can, by itself, trigger node 200 to perform an action.

One example of such an action and use is that node 200 processes the new event that it generated, using the stored event that was generated by another originator. For example, if the stored event data is an image that includes a given face, node 200 can process the newly generated event in order to identify faces that match those stored in the stored images using e.g. known per se face recognition algorithms. Another example of such an action is that node 200 uses the stored event data is to modify generation of future events generated by node 200. For example, if the stored event is a face, node 200 can switch its own event generation into face recognition mode. If the stored event is a license plate number, node 200 can switch event generation into license plate recognition mode. Node 200 can also change the generation of the future events e.g. by zooming the camera.

Another example is that node 200 can perform an action based on any relevant data extracted from the stored generated event data. For example, node 200 can use data relating to the originator node. Thus, if the originator node is a night camera, node 200 can change into night mode, and generate consequent events in night mode.

Note that the invention is not bound by the specific example illustrated above with respect to various embodiments of the presently disclosed subject matter.

Turning now to FIG. 6, it illustrates a flowchart exemplifying operations which are carried out at the parent node, in accordance with the presently disclosed subject matter. The operations described with reference to FIG. 6 can be performed for example by parent node 300 illustrated in FIG. 3.

According to certain embodiments of the presently disclosed subject matter, originator node may send generated event data to a parent node, for establishing new neighboring relationships to the originator node, e.g. by facilitating association of new neighbors to the originator node. Once a parent node obtains generated event data, it can then distribute it to other nodes in the network, such as its child nodes, its neighboring nodes and its parent node.

According to certain embodiments of the presently disclosed subject matter, a parent node, such as parent node 300, may obtain generated event data (block 601) in several ways.

As described above, a parent node may constitute the parent node in the physical network, of either or both the originator node and the receiving child node. In the latter case, both the originator node and the receiving node constitute child nodes of the parent node.

In some cases, where parent node 300 is a parent of the originator node, then parent node may obtain generated event data by receiving it directly from the originator node that sent data relating to a generated event for establishing new neighboring relationships to the originator node.

In some other cases, where the parent node is not a parent of the originator node, then a parent node may obtain generated event data either from one of its neighboring node (other parent nodes in the network which received the event data from the originator node being their child node, and the current parent node is neighbor of the other parent nodes), or from the grandparent node, which received the generated event data from one of its child nodes (other parent nodes in the network, which received the event data from the originator node being their child node).

Note that the network is not bound by the specific example illustrated above with respect to the network having three layers only (of child nodes, parent nodes, and a grandparent node). As such, a parent node may obtain generated event data by receiving it from another parent node that the current parent node is a neighbor of the other parent node) or from the grandparent node, while the neighboring parent node or the grandparent node are not themselves related or connected to the originator node, and these nodes themselves received it from other nodes in the network. Details relating to a parent node or a grandparent node sending generated event data were provided above with respect to FIG. 1.

In yet some other examples, parent node 300 can generate an event, thereby obtaining an event data relating to the generated event. In this case, parent node 300 constitutes an originator node. For example, parent node 300 can include an image acquisition means of the type of a video camera. Parent node 300 can generate an event by capturing an image by the video camera, and in this manner parent node 300 obtains data relating to the captured image.

Irrespective of the manner in which the parent node 300 obtained the generated event data, after obtaining the data, the parent node 300 can send the generated event data to one or more its child nodes (e.g. using child nodes data 319) to facilitate association of a new neighboring node to the originator node (block 603).

Any receiving child node is configured to store the generated event data, and later, to determine, based on the stored generated event data and data relating to a new event, generated by said child node, whether a condition has been met. If a condition is met, the receiving child node is configured to send a response to the originator node of the stored generated event data, where the response is indicative of meeting the condition. The originator node will then update its neighboring nodes data to include data relating to the receiving child node.

It should be noted that in case the parent node is the also the originator node of the event, then the receiving child node will send a response to the parent node, being the originator node, that a condition has been met. Parent node 300 can then update its neighboring data, e.g. parent neighboring nodes data 313 to include data relating to the receiving child node that sent the response. In such examples, parent node 300 takes two roles, as an originator node of an event and as a parent node to a child node. Notably, the parent node may then constitute its own parent node, when taking the role of the originator node.

According to certain embodiments of the presently disclosed subject matter, a parent node can send the generated event data to all its child nodes, and not send the generated event data to the originator node, if the originator node is one of its child nodes. In some examples, parent node 300 can store in addition, e.g. in child nodes data 319, child neighboring nodes data. For each child node, child nodes data 319 also includes data indicative of the neighboring nodes associated with each child node, respectively. Thus, in order to prevent receipt of duplicate events (thus reducing network communication overhead), parent node 300 can send generated event data to all its child nodes, and not send the generated event data to the originator node which is one of its child nodes, and to the neighboring nodes of the originator child node. In such cases, it is assumed that the neighboring nodes of the child originator node receive the generated event data from the originator child node itself.

As described with reference to FIG. 1, parent node 300 can also selectively send the event data to its parent node, i.e., the grandparent node of each of its child nodes (block 605), to facilitate association of new neighbors to the originator node. Sending the generated event data to the grandparent node is done in a similar way to that described above with reference to an originator node sending generated event data to its parent node, to facilitate association of new neighbors to the originator node.

In addition to sending the generated event data to the child node and possibly to the grandparent node, according to certain embodiments of the presently disclosed subject matter, parent node 300 can send the generated event data to one or more neighboring nodes of parent node 300 (block 607), e.g. using parent neighboring nodes data 313. Parent node 300 can send the generated event data to its neighboring nodes to facilitate association of a new neighboring node to the originator node.

Upon receipt of the generated event data, the receiving parent neighboring node can send the generated event data to its respective child nodes. Sending the generated event data by the parent neighboring node to its respective child node is carried out in a similar way to that described above with respect to parent node 300 sending the generated event data to its child nodes.

In some examples, parent node 300 can also receive updated data from other nodes in the network and perform an action based on the received updated data (block 609). For example, an originator child node updating its neighboring node data can send the updated neighboring node data to parent node 300. Parent node 300 receiving the updated data can update its own data accordingly, e.g. the child neighboring node data stored in child nodes data 319. Updating child nodes data 319 can be carried out e.g. by neighborhood handler 315. Based on the updated child nodes data 319, the following generated events data can be sent to all the child nodes of parent node 300, except the child originator node and its respective neighboring nodes.

In some of the examples, parent node 300 can also update parent neighboring nodes data 313 based on the updated child neighboring node data. Such an update assumes that each child neighboring node in the updated child neighboring node is associated with a respective parent node. Parent node 300 can update its neighboring nodes data to include data relating to some or all parent nodes of the child neighboring node. In such examples, parent nodes in the network are considered as neighboring nodes, if their respective child nodes are neighboring nodes.

FIG. 7 exemplifies operations which are carried out by several nodes in the system, in accordance with presently disclosed subject matter. FIG. 7 includes a finite state machine illustrating stages performed by a node, e.g. node 200, and a parent node, e.g. parent node 300, in the network. Node 200 represents a node having functionalities of both an originator node as well as a receiver node. The stages or transitions to states in the state machine should be read in line with the subject matter disclosed above with respect to FIGS. 1-6.

It should be noted that the state machine exemplified in FIG. 7 in order to demonstrate stages perform by nodes in the network, is different to the state machine described above with reference to the sequence of events.

Turning to the state machine in FIG. 7 and starting from state S0, S0 represents a main loop and illustrates an idle state of node 200. Once node 200 generates an event E (line T0.1) it then switches to state S1. If node 200 receives an event E from some other node in the network (line T0.2) then node 200 switches to state S7. Receiving an event in this respect should be considered as receiving generated event data, as discussed above. Once node 200 receives an event, it stores the received event E in its data storage (state S7) until a defined condition is met, for example, for a certain period of time, or until a certain number of events are received from a parent node, or are generated by node 200.

Moving now to state S1, after node 200 generates an event, it compares the generated event E with existing events stored in its data storage. The stored events were originated by other nodes and were received at node 200 by the parent node thereof. The comparison of two events is an example for determining whether a condition has been met. For example, comparison can be of two captured images to determine the degree of similarity between the images. If the newly generated image matches some other stored event, i.e., the images are similar to a certain degree, such that node 200 determines that the condition has been met, node 200 switches to state S2 (line T1.1). In state S2, node 200 replies by sending a response to the node which originated E (Creator), and the response is indicative that the condition has been met, i.e., that node 200 determined matching events. The originator (Creator) will update its neighboring data to include node 200 as a new neighboring node. Whether or not a match was found, and a response was sent to the originator (Creator) or in case that the created event does not match with any stored event, node 200 switches to state S3 (lines T2.1 and T1.2, respectively).

At state S3, node 200 sends the event E to all of its current neighbors Yi, as described, e.g. based on the neighboring nodes data. In some examples, high class neighbors receive more details of event E than lower class neighbors. For example, node 200 sends a full copy of the captured image to the say first n neighboring nodes according to a predefined criterion, e.g. to those neighboring nodes that have sent responses to some previous events in a short time duration, measured from the time that generated event data was sent from an originator node. Alternatively or additionally, node 200 sends sub-image of the captured image to the neighboring nodes which have sent responses to some previous events in longer time duration.

In case a defined condition is met (line T3.1), node 200 switches to state S4, in which node 200 sends the event E to its parent P. A defined condition can be for example, after a number of events generated from the previous sending of an event to the parent node (e.g. after 10 events), or after a time interval has passed from previous sending (e.g. 60 seconds). The condition can also be randomized, e.g. after a random time between 30 and 90 seconds or after a random number of events between 5 and 15.

If the condition has been met, and node 200 sent event E to the parent node, or in case the defined condition is not met, node 200 switches to state S5 (lines T4.1 and T3.2, respectively).

In state S5, node 200 waits for receiving responses. The responses can be received from any of neighboring nodes Yi, or from potential new neighboring nodes Zi that have received event E. Waiting can be for time t1. Once the time has passed, node 200 can update its stored neighboring data based on the responses that have been received, e.g. based on characteristics of the responses, as described above, or based on lack of receipt of responses from neighboring nodes, as described above with respect to the removal criterion. Node 200 can then send the updated neighboring nodes data to its parent node P. After waiting in state S5 for time duration that exceeds a given timeout (line T5.2) node 200 returns to state S0, the main loop.

Turning now to the states related to parent node 300, in state P0 parent node 300 receives data from nodes in the network.

If parent node 300 receives neighboring nodes data from one of its child nodes (line V0.1), parent node 300 switches to state P1. In state P1, parent node 300 updates its own neighboring data based on the received neighboring data. Upon completion of the update, parent node 300 switches to state P2, in which parent node 300 sends its updated neighboring data to its own parent (the grandparent of its child nodes) and returns to main loop state P0.

If, in state P0, parent node 300 receives an event E from a neighboring node or from its parent node (the grandparent node) (line V0.2), i.e., the originator node is not a child of parent node 300. Parent node 300 then switches to state P3. In state P3, parent node 300 sends the received event to all of its child nodes. Any child node is a potential new neighboring node to the originator node of event E. After sending, parent node 300 returns to state P0.

If, in state P0, parent node 300 receives an event E from a child node (line V0.4) then parent node 300 switches to state P4. In state P4, parent node 300 sends the event E to all of its child nodes and all of its neighboring nodes. Optionally, parent node 300 sends the event to some or all of its child nodes, and does not send the event to the originator child node, and the neighboring nodes of the originator child node.

In case a defined condition is met (line V4.1), parent node 300 switches to state P5, in which parent node 300 sends the event E to its parent P (the grandparent node). Similar conditions to those described above with respect to line T3.1 are also applicable in this case.

After some waiting time in state P4 or in state P5, e.g. a once a certain time has passed, parent node 300 returns to the main loop in state P0.

It should be noted that the process described at parent node 300 can represent the process at each parent node in the hierarchy of the network. As described above, the network should not be considered as limited to three layers only (child node, parent and grandparent). The process of receiving an event from a child node and sending it to the parent node switches iteratively up in the hierarchy. In each parent layer, the process is the same as described, ending at the root node. In some instances, the higher in the hierarchy the position of the parent node, the less often the condition for sending the event to the parent node should be met.

It should also be noted that the division into states is not binding, and that one or more states can be merged. For example, state S5 and state SO or states P4 and P0 could be merged into one state, thereby enabling receiving events while waiting for responses. In a similar way, separation into sub-states is also possible. The presentation of the current states is for clarity reasons only.

It is noted that the teachings of the presently disclosed subject matter are not bound by the flowcharts and stage machine illustrated in FIGS. 4-7, and the illustrated operations may occur not in the illustrated order. For example, operations 605 and 607 shown in succession can be executed substantially concurrently, or in the reverse order. It is also noted that whilst the flowchart is described with reference to elements of node 200 and parent node 300, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method for communicating between nodes, by a processor of a originator node, comprising:
providing a data storage that is associated with the originator node for storing neighboring data indicative of at least one neighboring node of the originator node;
generating an event; sending a generated event data relating to said generated event to at least one neighboring node for facilitating processing of said generated event data by a processor of each one of said at least one neighboring node;
selectively sending said generated event data to a parent node associated with said originator node, for facilitating the association of at least one new neighboring node to said originator node;
if a response to said sent generated event data, which originated from at least one new neighboring node, is received at said originator node, then based on said response, updating said neighboring data to include data indicative of the at least one new neighboring node.

2. The method of claim 1, wherein each one of said at least one neighboring node is associated with a class out of at least two classes.

3. The method according of claim 2, wherein said sending generated event data to a neighboring node associated with a first class of said at least two classes includes sending a first generated event data, and said sending generated event data to a neighboring node associated with a second class of said at least two classes includes sending a second generated event data, wherein said second generated event data is at least partially different than said first generated event data.

4. The method of claim 1, wherein said generated event is associated with at least one event characteristic.

5. The method of claim 4, wherein said event characteristic is content aware.

6. The method of claim 4, wherein said event characteristic is non-content aware.

7. The method of claim 2, further comprising:
in response to sending the generated event data to at least one neighboring node, receiving a neighboring response from the at least one neighboring node, and updating the class associated with the at least one neighboring node as either said first class, said second class, or a trash class, depending on characteristics of the response.

8. The method of claim 1, further comprising:
removing neighboring data that pertains to a neighboring node if a removal criterion is met.

9. The method of claim 1, wherein said selectively sending said generated event data comprises determining that a condition is met, and sending said generated event data.

10. The method of claim 1, wherein each one of the neighboring nodes in the neighboring data is associated with at least one group, wherein said sending the generated event data includes sending the generated event data to a first neighboring node associated with one group, and not sending the generated event data to any second neighboring node associated with another group.

11. The method of claim 1, further comprising:
sending at least part of the neighboring data to the parent node.

12. A method for communicating between nodes by a processor of a receiving node, comprising:
providing a data storage that is associated with the receiving node for storing a generated event data relating to at least one event generated by an originator node and received from a parent node that is associated with said receiving node;
generating a new event;
determining based on data relating to said newly generated event and said stored generated event data whether a condition has been met; and
if the condition is met, sending a response to the originator node indicative of meeting the condition thereby facilitating association of the receiving node to said originator node as a new neighboring node.

13. The method of claim 12, wherein said data storage further stores at least one function, each function is indicative of how to determine whether the condition is met, the method further comprising:
retrieving at least one stored function; and
based on the at least one retrieved function, determining whether the condition is met.

14. The method of claim 13, wherein said at least one function is characterized by at least one predefined sequence of events, and wherein the condition is met if a generated sequence of events of said data relating to said newly generated event and said generated event data fulfill said function character.

15. The method of claim 12, wherein said data storage further stores neighboring data indicative of at least one neighboring node of the receiving node, wherein said receiving node further constitutes an originator node, the method further comprising:
sending newly generated event data relating to said newly generated event to at least one neighboring node, for facilitating processing of said newly generated event data by a processor of each one of said at least one neighboring nodes; and selectively sending data relating to said newly generated event to the parent node for facilitating the association of at least one new neighboring node to said receiving node.

16. The method of claim 1, wherein said data storage further stores stored event data relating to at least one event generated by at least one other originator node, and received from the parent node, the method further comprising:
determining based on data relating to said generated event and said stored event data whether a condition has been met; and
if the condition is met, sending a response to the at least one other originator node indicative of meeting the condition thereby facilitating association of the originator node as a new neighboring node to said at least one other originator node.

17. A method for facilitating association of a new neighboring node to an originator node, by a processor of a parent node, the method comprising:
providing a data storage that is associated with the parent node for storing child nodes data indicative of at least one child node of the parent node;
obtaining a generated event data relating to an event generated by the originator node;
sending said generated event data to at least one child node, for storing said generated event data in a child nodes data storage associated with said child node, determining by said child node based on said generated event data and data relating to a second event generated by said child node whether a condition has been met, and originating from said child node, a response to the originator node indicative of meeting the condition, thereby facilitating association of the child node as a neighboring node to said originator node.

18. The method of claim 17 wherein said generated event data is obtained from a child node of said parent node, said child node constituting the originator node.

19. The method of claim 17 wherein said generated event data is obtained from a grandparent node, constituting a parent node of said parent node and a grandparent node to each one of said child nodes of said parent node.

20. The method of claim 17 wherein said data storage further stores neighboring data, indicative of at least one neighboring node of the parent node.

21. The method of claim 20, wherein said generated event data is obtained from a neighboring node of said parent node.

22. The method of claim 18 wherein said sending the generated event data includes sending said generated event data to at least one child node of said parent node and not sending said generated event data to said originator.

23. The method of claim 22 wherein said child data is further related to child neighboring nodes indicative of at least one neighboring node associated with each of said at least one child node,
wherein said sending the generated event data includes sending said generated event data to at least one child node of said parent node and not sending said generated event data to at least one of said neighboring nodes of said at least one child node of said parent node.

24. The method of claim 20, wherein said generated event data is obtained from a child node of said parent node, the method further comprising:
sending said generated event data to at least one neighboring node.

25. The method of claim 18, further comprising:
selectively sending said generated event data to a grandparent node, constituting a parent node of said parent node, and a grandparent node to each one of said child nodes of said parent node, for facilitating the association of at least one new neighboring node to said originator node.

26. The method of claim 17, wherein said child nodes data is further related to child neighboring node data indicative of at least one neighboring node associated with each of said at least one child node, the method further comprising:
receiving from said at least one child node at least part of an updated child neighboring node data; and
selectively updating the respective child neighboring node data stored in said data storage.

27. The method of claim 18, wherein said data storage further stores neighboring data, indicative of at least one neighboring node of the parent node, and wherein each of said at least one child neighboring node in said child neighboring node data is further associated with a respective parent node, and said at least part of an updated child neighboring node data is further indicative of a respective parent node for each updated child neighboring node, the method further comprising:
selectively updating the stored neighboring data indicative of at least one neighboring node of the parent node to include data related to at least one updated respective parent node associated with the updated child neighboring node.

28. A computerized system enabling communication between nodes, the system comprising:
a plurality of originator nodes, each originator node is associated with an originator node's data storage configured to store neighboring data indicative of at least one neighboring node of the originator node;
a plurality of receiving nodes, each receiving node is associated with a receiving node's data storage configured to store generated event data relating to at least one event generated by an originator node of said plurality of originator nodes;
a plurality of parent nodes, each parent node is associated with a parent node's data storage configured to store child nodes data indicative of at least one child node of the parent node, and each parent node constituting a parent to at least one receiving node of said plurality receiving nodes,
wherein an originator node of said plurality of originator nodes is configured to generate an event and send generated event data relating to said generated event to at least one neighboring node, for facilitating processing of said generated event data by a processor of each one of said at least one neighboring nodes;
wherein a parent node of said plurality of parent nodes is configured to obtain said generated event data and to send said generated event data to at least one child node;
wherein a receiving node of said plurality of receiving nodes is configured to receive said generated event data from said one parent node, to store said generated event data in a receiving node's data storage associated therewith, wherein said receiving node is configured to determine based on said generated event data and data indicative of a second event, generated by said receiving node, whether a condition has been met; and
if the condition is met, to send a response to the originator node indicative of meeting the condition;
said originator node is configured to update said neighboring data to include data indicative of said receiving node.

29. A computer program product implemented on a non-transitory computer useable medium having computer readable program code embodied therein for communicating between nodes, by a processor of an originator node, the computer program product comprising:
computer readable program code for causing the computer to provide a data storage that is associated with the originator node for storing neighboring data indicative of at least one neighboring node of the originator node;
computer readable program code for causing the computer to generate an event;
computer readable program code for causing the computer to send generated event data relating to said generated event to at least one neighboring node for facilitating processing of said generated event data by a processor of each one of said at least one neighboring node;
computer readable program code for causing the computer to selectively sending said generated event data to a parent node associated with said originator node, for facilitating the association of at least one new neighboring node to said originator node;
computer readable program code for causing the computer if a response to said sent generated event data, originated from at least one new neighboring node, is received at said originator node, then based on said response, updating said neighboring data to include data indicative of the at least one new neighboring node.
